(19) United States
(12) Patent Application Publication
(10) Pub. No.: US 2007/0277111 A1
(43) Pub. Date: Nov. 29, 2007

(54) GRAPHICAL USER INTERFACE USING PERCEPTION-ACTION ICONS AND A METHOD THEREOF

(75) Inventors: Kevin B. Bennett, Dayton, OH (US); Lawrence G. Shattuck, Carmel, CA (US); Christopher P. Talcott, Los Angeles, CA (US); Silas G. Martinez, Clarksville, TN (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: WRIGHT STATE UNIVERSITY, Dayton, OH (US)

(21) Appl. No.: 11/669,501

(22) Filed: Jan. 31, 2007

Related U.S. Application Data
(60) Provisional application No. 60/764,226, filed on Feb. 1, 2006.

(51) Int. Cl. G06F 3/048

(52) U.S. Cl. 715/763

(57) ABSTRACT

The present invention provides a computerized near-real time resource deployment decision analysis tool providing a graphical user interface using perception-action icons that enables instant comparison of various resource parameters as well as progress according to plan, and a method thereof. The graphical user interface and method thereof provides an effective interface design strategy for both law-driven (e.g., process control) and intent-driven (e.g., information retrieval) domains using perception-action icons. Results unequivocally indicate that a graphical user interface with perception-action icons produced significantly better performance over prior art methods.

### BACKGROUND OF THE INVENTION

The present invention relates generally to computerized decision support systems, and in particular to a near-real time resource deployment decision analysis tool providing a graphical user interface using perception-action icons that enables instant comparison of various resource parameters as well as progress according to plan and a method thereof.

Cognitive systems engineering provides a general framework for the development of effective computerized decision support tools. The foundation of this approach is that an analysis and description of domain constraints (i.e., the regularity in a domain, or alternatively, the nature of the work to be done) are essential in developing effective interfaces. Prior art efforts have developed a continuum to categorize different domains in terms of their constraints. At one end of the continuum are “law-driven” domains in which the unfolding events arise from the physical structure and functionality of the system itself (e.g., process control). In “law driven” domains, users are highly trained and specialized such that they can respond to the demands that are created by the domain. At the opposite end of the continuum are “intent-driven” domains where the unfolding events arise from the user's intentions, goals, and needs (e.g., information search and retrieval). Users typically interact with systems in the “intent-driven” domain on a more casual basis and their skills, training, and knowledge are far more heterogeneous. The interface design strategy that will be successful for a particular domain is determined by the domain's location on this continuum.

In the prior art, cognitive systems engineering literature has provided excellent examples of design strategies for domains that fall at either of the two ends of the continuum. Currently, it is believed that the most effective design strategy for law-driven domains is to develop analogical visual displays that utilize geometrical forms to directly reflect domain constraints. The most effective design strategy for intent-driven domains is to develop spatial metaphors (e.g., the desktop metaphor) that relate interaction requirements to more familiar concepts and activities.

The design strategy (or perhaps strategies) that are appropriate for domains that fall in the middle of this continuum is less clear. These domains are characterized by the presence of both law-driven constraints and intent-driven constraints that are roughly equivalent in terms of their importance in shaping overall system behavior. The term “intermediate” will be used to describe this general category of domains. A good example of an intermediate domain is military command and control. There are law-driven constraints that arise from an extensive technological core (e.g., weaponry, sensors, communication, etc.). However, there are also intent-driven constraints, e.g., accomplishing a mission according to a plan. In addition, the difference in intentions between friendly and enemy forces is one obvious factor, but intent also plays a substantial role within a military organization.

For example, in one particular “intermediate” domain, tactical decision making in the Army is characterized by fast-moving forces, rapidly-changing situations, and an abundance of data. The task force commander pursues mission objectives by marshaling forces, resources, and opportunities so that “combat power” is maximized and available for delivery at an appropriate point in space and time. Task force-level command and control has historically occurred at the “tactical operations center”—a semi-mobile assortment of trailers, trucks, equipment, and staff. However, both the physical location where these activities occur and the technological systems that support them have undergone dramatic changes in recent years. Most commanders now direct tactical operations from fighting vehicles located at forward positions in the battlefield using wireless networked computers with a command and control graphical user interface, such as for example, the “Force XXI Battle Command Brigade and Below” (FBCB2) interface. However, studies have indicated that such prior art interfaces and related technology contributed directly to poor decision-making. Commanders and their staffs were often inundated by the amount of data and the way in which they were presented, particularly during combat situations when high stress and heavy workloads were imposed.

Accordingly, a graphical user interface capable of providing more effective decision support for mobile commanders during tactical operations is needed.

### SUMMARY OF THE INVENTION

It is against the above background that the present invention provides a “perception-action icons” design strategy to meet the design challenges imposed by an intermediate domain: military command and control. The present invention provides a computerized near-real time resource deployment decision analysis tool providing a graphical user interface using perception-action icons that enables instant comparison of various resource parameters as well as progress according to plan and a method thereof. The graphical user interface and method thereof provides an effective interface design strategy for intermediary domains between both law-driven (e.g., process control) and intent-driven (e.g., information retrieval) domains using perception-action icons. Results unequivocally indicate that a graphical user interface with perception-action icons produced significantly better performance over prior art methods.

In one embodiment, a graphical user interface for use as a near-real time resource deployment decision analysis tool on a computer provided with data corresponding to information about external resources is disclosed. The graphical user interface comprises at least one perception action icon having a plurality of visual objects organizing the data into resource categories enabling instant comparison thereof and providing analog, digital, and categorical representations of status of the external resources within each of the resource categories based on the data. Each one of the visual objects is configured to provide a visual change when a corresponding one of the resource categories changes the status at least from an update to the data.

In another embodiment, a method for providing generalized and detailed representations of data corresponding to information about external resources provided to a computer using a graphical user interface is disclosed. The method comprises displaying the graphical user interface; and displaying at least one perception action icon on the graphical user interface. The perception action icon has a plurality of visual objects organizing the data into resource categories enabling instant comparison thereof and providing analog, digital, and categorical representations of status of the external resources within each of the resource categories based on the data. Each one of the visual objects being configured to provide a visual change when a corresponding one of the resource categories changes the status at least from an update to the data.

In still another embodiment, a computer system provided with data corresponding to information about external resources is disclosed. The computer system comprises a graphical user interface providing at least one perception action icon. The perception action icon has a plurality of visual objects organizing the data into resource categories and providing analog, digital, and categorical representations of status of the external resources within each of the resource categories based on the data. Each one of the visual objects is configured to provide a visual change when a corresponding one of the resource categories changes the status at least in respects to an update to the data.

These and other features and advantages of the invention will be more fully understood for the following detailed description of the invention taking together with the accompanying drawings.

### BRIEF DESCRIPTION OF THE DRAWINGS

The following detailed description of the embodiments of the present invention can be best understood when read in conjunction with the following drawings, where like elements are indicated with like reference numerals, and in which:

FIG. 1A is a depiction of one embodiment of a “perception-action” icon used in a direct perception graphical user interface according to the present invention.

FIG. 1B is a depiction of another “perception-action” icon embodiment provided on an electronic graphical map display according to the present invention and provided with additional “roll over” information that appears when a cursor or mouse pointer is positioned over the icon.

FIGS. 2A, 2B, 2C and 2D are depictions of an electronic graphical map display embodiment with direct manipulation objects according to the present invention, in which FIG. 2A is a default configuration with company level “perception-action” icons located on the map display and a battalion level perception-action icon located in a holding area, FIGS. 2B and 2C illustrate manipulations of a perception-action icon on the map display which produces views of combat resources at finer grains of resolution, and FIG. 2D illustrates manipulation of a perception-action icon in the holding area which produces views of combat resources at a courser grain of resolution.

FIGS. 3A and 3B are depictions of a prior art combat graphical user interface (FBCB2), in which FIG. 3A shows a default configuration of the interface (“Main Screen”) with representations of individual tanks and Bradley vehicles that would appear if a platoon were on the interface map and an operator pointed and clicked on the platoon to expand, and FIG. 3B shows a pop-up window activated via pushing a function button, in order to view categorical summary information of combat resources at the company level (“Combat Messages”).

FIGS. 4A and 4B are additional depictions of the prior art combat graphical user interface of FIG. 3A, in which FIG. 4A shows a pop-up window with alpha-numeric description of combat resources at the company level (“Long Form Message”) which is activated by selecting a function button (e.g., “D/1-22”) in a Combat Messages screen, and FIG. 4B shows a pop-up window with a list of buttons corresponding to platoons (and Long Form Messages upon their activation) which is activated by selecting a “FIPR 12” button in a default configuration.

FIGS. 5A and 5B are a tabulated empirical results of tests conducted with the present invention.

FIGS. 6A, 6B, and 6C are a graphs of Mean levels of performance of the present invention.

FIG. 7 is a depiction of a default normal operational mode screen of a graphical user interface embodiment according to the present invention.

FIG. 8A is a depiction of another perception action icon embodiment for displaying friendly combat resources according to the present invention.

FIG. 8B is a depiction of a resource display embodiment according to the present invention.

FIG. 8C is a depiction of semi-transparent icon embodiments used in a graphical map display embodiment according to the present invention.

FIG. 9 is a depiction of a navigational scheme embodiment for detailed resource information used in the resource display of FIG. 8B according to the present invention.

FIG. 10 is a depiction of force equivalence and force ratio trend display embodiments (early in engagement) used in a graphical user interface according to the present invention.

FIG. 11 is a depiction of the force equivalence and force ratio trend display embodiments of FIG. 10 late in engagement according to the present invention.

FIG. 12 is a depiction of a plan review mode screen of a graphical user interface embodiment according to the present invention.

FIG. 12A is a depiction of a resource display presented in the plan review mode screen of the embodiment of FIG. 12 according to the present invention.

FIG. 13 is a depiction of an enemy combat resource display embodiment according to the present invention.

FIG. 14. is a depiction of an embodiment of a synchronization mode screen of a graphical user interface embodiment according to the present invention.

FIG. 15 is a block diagram of one system embodiment according to the present invention.

Skilled artisans appreciate that elements in the figures are illustrated for simplicity and clarity and have not necessarily been drawn to scale. For example, the dimensions of some of the elements in the figures may be exaggerated relative to other elements, and with conventional parts removed, to help to improve understanding of embodiments of the present invention.

### DETAILED DESCRIPTION OF THE INVENTION

With reference to figures, the present invention provides a coordinated set of graphical formats that present critical information during a tactical engagement, thereby providing more effective decision support. It is to be appreciated that although the illustrative embodiment is directed to military command and control, the concepts of the present invention could easily be adaptable to the development of novel decision-making programs for a broad range of civilian business application such as in the financial, construction and architectural markets, or for materials engineering applications.

Perception-Action Icons

Cognitive systems engineering emphasizes that the goal in interface design is to bring the highly efficient perceptual-motor skills of the human to bear on the problem of human-computer interaction. In particular, successful interaction with the natural environment depends upon a dynamic and continuous “perception-action loop” that draws upon highly-efficient “skill-based” behaviors. The graphical user interface according to the present invention, referred to as the Representation Aiding Portrayal of Tactical Operations Resources interface (hereinafter referred to as the “RAPTOR interface”), achieves and maintains an intact perception-action loop through “perception-action” icons that provide integrated display (direct perception) and control (direct manipulation) design components that preserve the loop's integrity. Each component of the “perception-action” icons of the RAPTOR interface will be described hereafter in greater detail.

Direct Perception

Achieving direct perception requires at least two different sets of mappings. One set of mappings involves the relationship between the constraints of the work domain and the informational content encoded into the graphical representations (i.e., are appropriate categories of domain information and relations available in the interface?). This will be referred to as “content mapping.” A second set of mappings involves the relationship between the visual properties of the graphical representations and the perceptual capabilities and limitations of the observer (i.e., have the domain constraints been encoded or represented in the interface so that they can be easily obtained?). This will be referred to as “form mapping.” The quality of these mappings will determine the extent to which the affordances of the domain, and therefore the potential for appropriate control actions to be executed, will be available for pick-up by the observer.

TABLE 1
Abstraction hierarchy analysis

| Abstraction Hierarchy | Military Tactical Operations | RAPTOR Interface |
|---|---|---|
| Goals, Purposes, & Constraints | Mission objectives, collateral | |
| | damage, public perception, etc. | |
| Abstract Functions & Priority | Combat power, value of mission | Categorical combat power |
| Measures | objectives vs. resource | indicator for unit |
| | expenditure; probability of | |
| | success/failure, etc. | |
| General Functions & Activities | Command & control, maneuver, | Activity Symbol indicating role |
| | combat service support, air | in battle |
| | defense, intelligence, fire | |
| | support, mobility & | |
| | survivability, etc. | |
| Physical Processes & Activities | Vehicles (speed, | Quantitative indicators for |
| | maneuverability), Weapons | combat parameters; range fan |
| | (power, range), Sensors | for primary munitions |
| | (sensitivity, range), Terrain | |
| | (avenues of approach), etc. | |
| Physical Form & Configuration | Physical location of units, | Terrain map, position of |
| | physical characteristics of terrain | graphical form. |
| | and weather, etc. | |

Content Mapping

In one particular application of the present invention, an abstraction hierarchy analysis of Army tactical operations at the battalion level was conducted using analytical tools to discover the constraints (i.e., the relational invariants) of a work domain. A partial listing is provided in the left section of Table 1 provided above. The first set of mappings (i.e., content) for the RAPTOR interface are summarized in the right-hand side of Table 1, which is an abstraction hierarchy analysis of Army battalion during tactical operations resulting in the corresponding visual indicators for the RAPTOR interface.

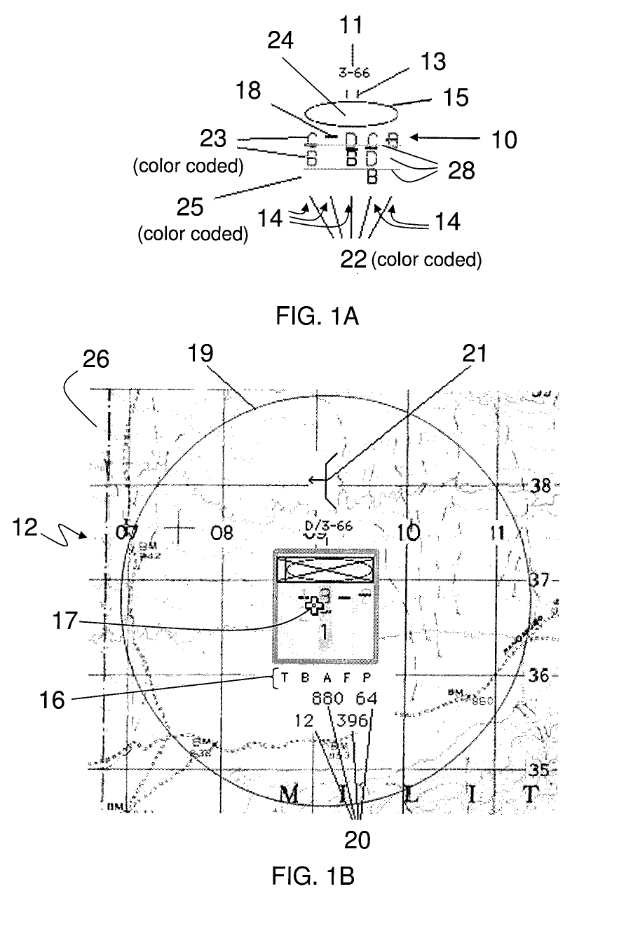

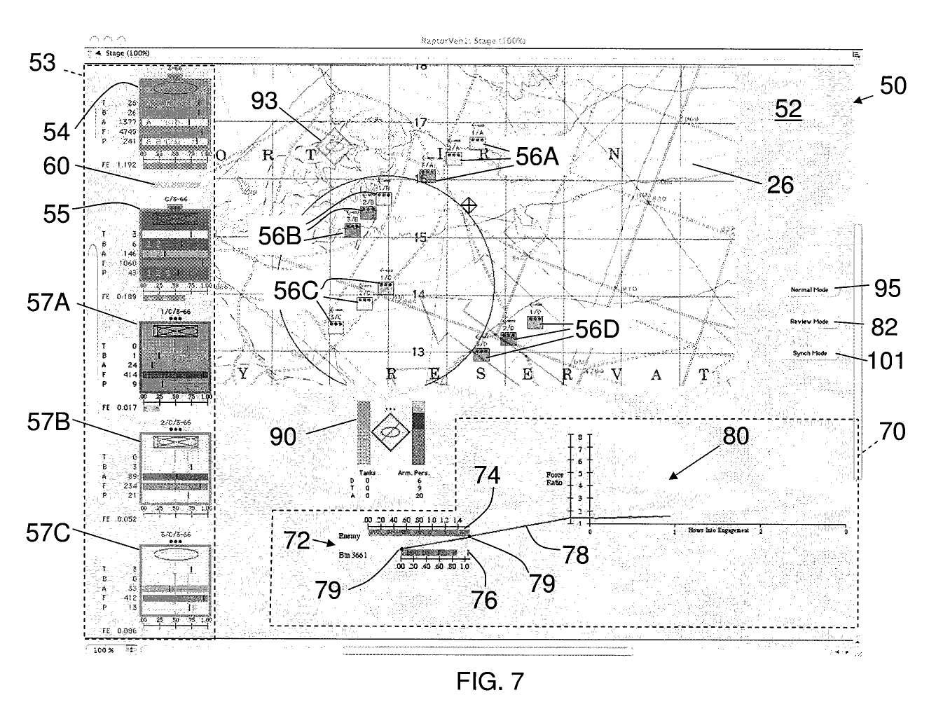

An example of a perception-action icon of a unit at a battalion echelon level according to one embodiment is illustrated by FIG. 1A and generally indicated by symbol 10, and associated “roll-over” behaviors of another embodiment of a company level perception-action icon is illustrated in FIG. 1B and generally indicated by symbol 12. It is to be appreciated that the combat power of a unit (i.e., its military force) is a fluctuating commodity that ebbs and flows due to resources expended during battle and resources gained during reinforcement. In the illustrated embodiments of FIGS. 1A and 1B, the tangible contributions to a unit's combat power are determined by the values of five combat resource parameters 14, either represented in columns (FIGS. 1A and 1B), or rows (FIGS. 7, 9 and 12), and optionally designated with a legend 16, such as illustrated in the embodiment of FIG. 1B. In the illustrated embodiment of FIG. 1B, the legend 16 has symbols T, B, A, F, P which stand for Tanks, Bradley personnel carriers, Ammunition, Fuel, and Personnel, respectively. The total percentage of each resource parameter 14 is represented by the vertical position of an analog marker 18 relative to the bottom (0%) and top (100%) and/or by digital values 20 of summed category resource quantities, such as shown in FIG. 1B. In addition, the categorical status of each resource parameter 14 is represented by a background color code (i.e., Green: 100-85%, Amber: 84-70%, Red: 69-50%, and Black: <49%), herein referred to as the resource parameter mat, and indicated by symbol 22. Other information includes standard Army unit identification symbol 11, unit size symbol 13, and type symbol 15. Also, at the company level, rolling over the company level “perception-action” icon 12 with a mouse pointer 17, such as illustrated in FIG. 1B, a range envelope 19 specifying the weapons envelope (FIG. 1B) for the unit's primary munitions is displayed, and disappears with the mouse pointer 17 is removed from over the icon 12. The unit's role in the current tactical operation is also indicated through standard Army Unit Activity symbols 21, e.g., the activity symbol in FIG. 1B indicates that the battalion is in an offensive attack mission.

Color coded alpha-numerical symbols 23 can reside on each resource parameter mat 22. These symbols indicate that the categorical status (i.e., Green: 100-85%, Amber: 84-70%, Red: 69-50%, and Black: <49%) of a combat parameter for a lower level unit is different than the categorical status for that parameter at the higher level unit. For example, as shown in FIG. 1A, the presence of the green letter “C” 23 in the left-most resource parameter mat 22 indicates that the categorical status of Company C for tanks (green categorical status) is different than the categorical status of the battalion for tanks (amber categorical status, the color code of the left-most resource parameter mat 22). Similarly, the presence of the red letter “B” 23 appearing on the left-most resource parameter mat 22 indicates that the categorical status of tanks for Company B is red (also different from the battalion). Conversely, the lack of the letters “A” and “C” on the left-most resource parameter mat indicate that the categorical status of tanks in Companies A and D are the same as the categorical status of the battalion (amber in this case).

The freshness of the data collected from organic and remote sources is indicated by a color coded elapsed time border or indicator 25 provided around the perception-action icons 10 and 12. As time passes without an update to the collected data used by the system to provide the statuses in each perception action icon, the color of the elapsed time indicator 25 fades or changes color. In addition to the color coded alpha-numerical symbols 21 and resource parameter mats 22, a background mat 24 of the entire perception action icon 10 and 12, around which the time indicator 25 borders, is also color coded to indicate a percentage range of availability (i.e., Green: 100-85%, Amber: 84-70%, Red: 69-50%, and Black: <49%) of the entire unit. Finally, color coded boundaries 28 are provided to indicate approximately how close the analog indicators 18 are from a particular a percentage range represented by the color coded. The information presented by the perception action icon corresponds to the level of physical processes and activities in the abstraction hierarchy. Information at the level of physical form and configuration includes the physical characteristics of the battlefield terrain, such as provided by a map display 26, and the physical location of the unit thereon. Accordingly, the perception action icon in one embodiment can be presented on the map display 26 as depicted by FIG. 1B. This information corresponds to the level of general functions and activities. It is to be appreciated that the map display 26 may be any image, drawing, illustration, combination thereof, etc., by which to represent space in two or three dimensions and relations between objects within that space.

Form Mapping

The second set of mappings (i.e., forms) involves the relationship between the visual properties of the display and the perceptual capabilities/limitations of the observer. In tactical operations the combat power of a unit is perhaps the most critical information to be presented; the tangible contributions to a unit's combat power consist of the five combat parameters. There are at least two categories of graphical formats that could be used: 1) a display where the combat parameters are mapped into a single geometrical form or 2) a display where each combat parameter has its own unique representation. Both of these formats can produce emergent features and therefore can qualify as “configural” displays; however, to facilitate discussion the former will be referred to as configural displays and the latter will be referred to as “separable” displays.

The proper choice between these two formats depends upon the inherent relationships between the domain variables to be presented. A configural display is the appropriate choice when the individual variables are tightly-coupled (i.e., interactions between individual variables produce higher-order domain properties). Under these circumstances a properly-designed configural display will produce salient, higher-level visual properties (i.e., emergent features) that correspond to these higher-order domain properties. However, when the individual variables are loosely-coupled (they do not necessarily interact to produce well-defined higher-level domain properties) a configural display will produce salient visual properties (i.e., emergent features) that are meaningless, yet at the same time quite difficult to ignore.

The domain analyses revealed that the five combat parameters are not tightly-coupled: the relationship between them can vary substantially across different contexts (e.g., offensive vs. defensive missions). Thus, in one embodiment, the RAPTOR interface incorporates unique representations for each of the combat parameters (see FIG. 1A). Note that the pattern of relative heights for the analog indicators 18 can produce a limited form of configurality that matches the loosely coupled relationships that characterized the combat parameters.

A second set of considerations in form mapping involves more specific characteristics of the display. The constraints in complex, dynamic domains will be hierarchically structured and nested; there is a corresponding need to visually segregate the information that appears in the interface. The challenge is to provide visual information that reflects the inherent structure and the relative importance of the corresponding domain information. Effective mappings at this level were devised for the RAPTOR interface. For example, the most critical piece of information (combat power of a unit) is represented by the most salient visual feature in the graphical format (the background color code of the unit's icon 24). Information at an intermediate level of importance (individual combat parameters, their values and relationships) was presented through visual features (background parameter mats, analog percentage indicators) at an intermediate level of salience. Basic information (e.g., unit's identification, type, and size symbols) is presented at the lowest level of visual salience. Finally, some information (munitions envelope, activity symbol, and digital values of combat parameters) was only available when the mouse rolled over an icon, thereby providing access to this information but avoiding clutter.

Direct Manipulation

Unlike prior art methods, such as for example, pull-down menus which do not constitute direct manipulation, the icons in the RAPTOR interface achieve the design goal of direct manipulation, wherein in the illustrated embodiment units at each echelon level can pursue collective or individual mission objectives. It is to be appreciated that in a military command and control environment, it is an essential requirement of a commander to consider the combat resources and activities at each echelon level. This requirement imposes substantial demands on the commander and his staff. For example, in the illustrated embodiment there are at least 17 echelon levels that a commander needs to consider: one at the battalion level, four at the company level (A, B, C, and D) and twelve at the platoon level (1, 2, and 3 for each company). To complicate matters further the commander is required to track the five combat resources for each of these units and may need to consider these resources in the context of the battlefield terrain, since it has a substantial impact on a variety of factors relevant to tactical operations.

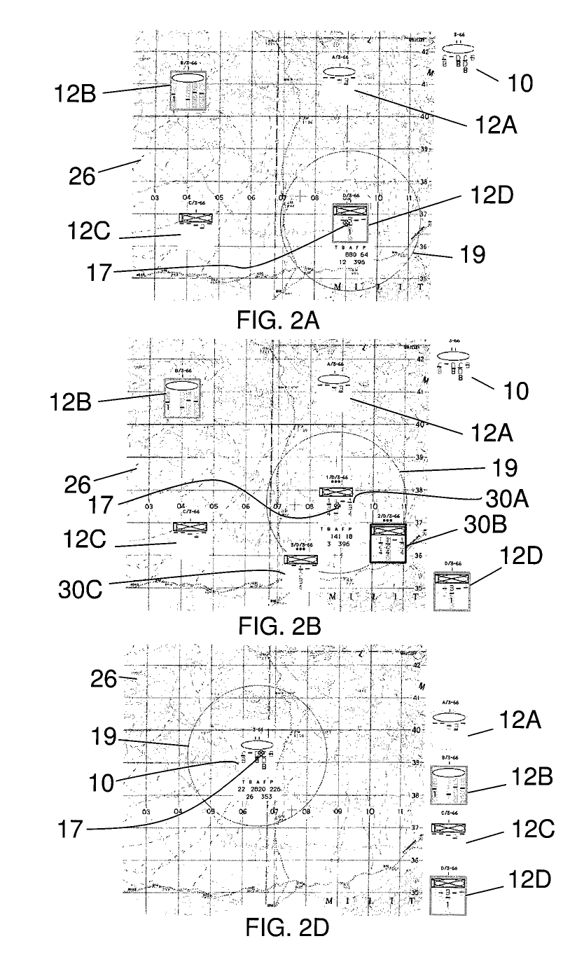

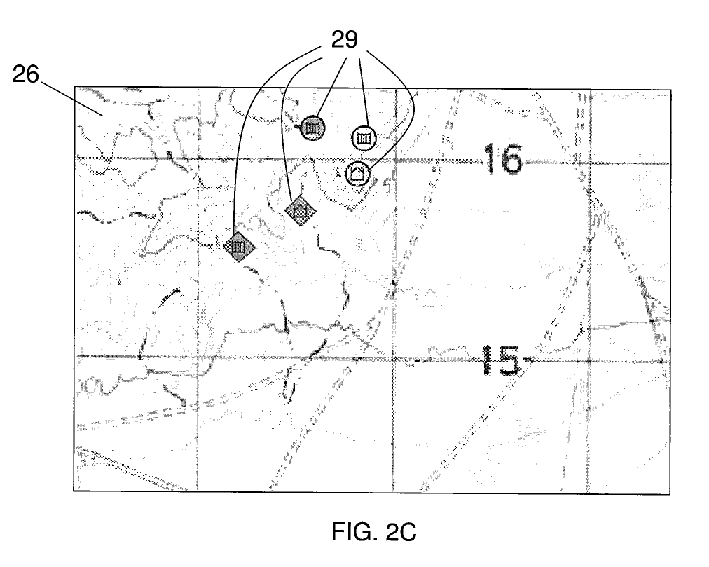

With references to FIGS. 2A, 2B, 2C and 2D, the direct manipulation of the graphical icons (i.e., pointing at and clicking on them) in the RAPTOR interfaces allows an individual to execute control functions regarding echelon level. The default configuration of the RAPTOR interface illustrated in FIG. 2A presents the four company icons 24A, 24B, 24C, and 24D on the map display 26 and the battalion icon 10 off the map display. Clicking an icon on the map provided a finer grain of resolution. For example, a pointing and clicking on the D company icon 12D depicted in FIG. 2A would replace it with the three associated platoon icons 30A, 30B, and 30C (FIG. 2B). Pointing at and clicking on an icon that appears on the map removes that icon and replaces it with the icons of the next echelon down. As illustrated in FIG. 2C, this pointing and click process can proceed until individual vehicles 29 are located on the map display 26. Conversely, clicking an icon off the map display 26 provided a courser grain of resolution by replacing existing icons on the map display with those at the level of the icon that was clicked, such as for example, the battalion icon 10 (FIG. 2D). As illustrated, the range envelope 19 for the unit's primary munitions and the unit's identification, type, and size symbols is provided with the battalion icon 10. Thus, the objects of interest (icons representing units of action) are manipulated directly to change the resolution of, and the context in which, information about friendly combat resources was displayed.

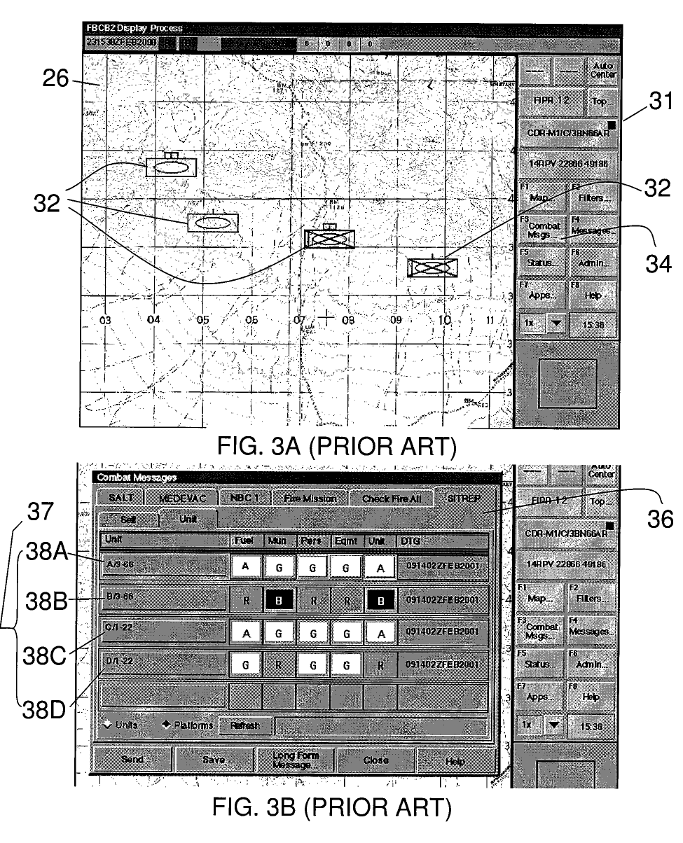

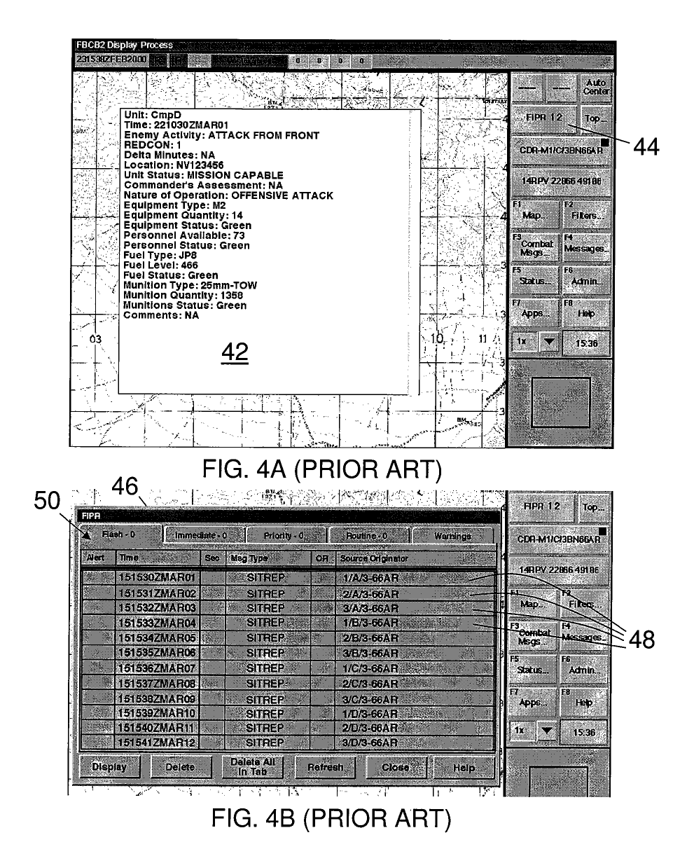

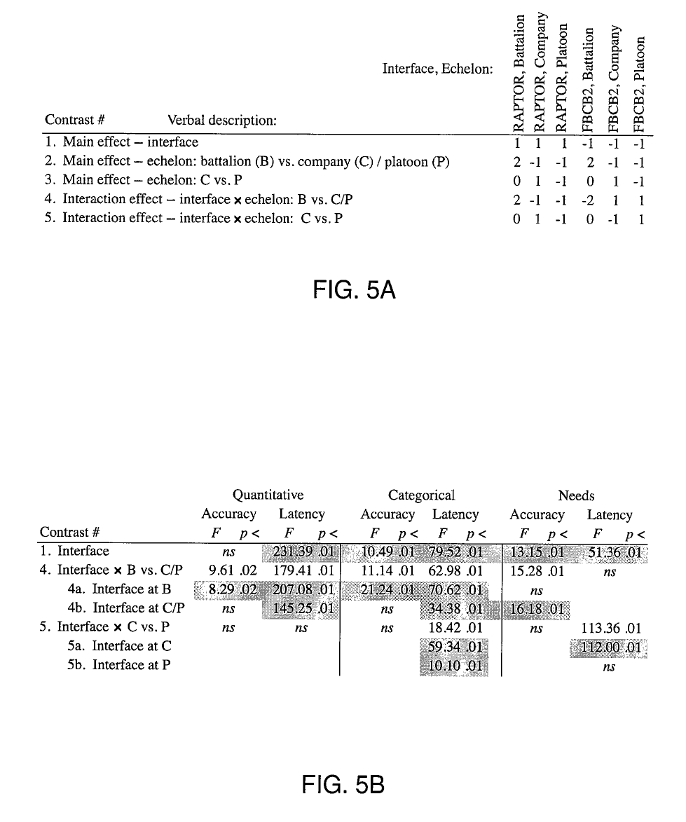

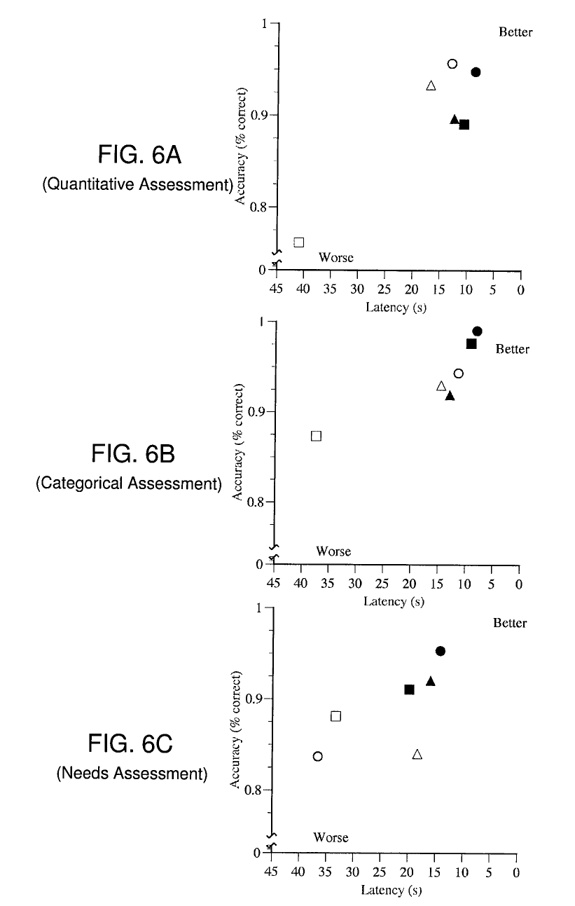

The perception-action icons design strategy in RAPTOR interface stands in sharp contrast to a prior art Army command and control interface, known as the “Force XXI Battle Command Brigade and Below” (FBCB2) interface. In order to better under stand the experimental study conducted and discussed in a later section in reference to FIGS. 5A, 5B, 6A, 6B, and 6C, the features of the FBCB2 interface that are relevant for obtaining friendly forces information will be described hereafter with reference made to FIGS. 3A, 3B, 4A, and 4B. FIG. 3A illustrates the “Main Screen” 31 of the FBCB2 interface; symbols 32 for the four companies of a battalion are present on the map display 26. The “F3 Combat Msgs” button 34 is clicked to access company-level information regarding combat resources. The “Combat Messages” screen 36 (FIG. 3B) appears and presents a matrix with rows 37 corresponding to the four companies (e.g., “A/3-66”, “B/3-66”, “C/1-22”, “D/1-22”) and columns 40 corresponding to combat readiness parameters (e.g., “fuel”). The matrix cells present a categorical estimate of each company's combat parameter strength through color-coding and a letter indicator (e.g., “B” for black). More detailed data can be obtained by activating the company's button 38A, 38B, 38C and 38D in the left-most “Unit” column (e.g., “D/1-22”), which produces a “Long Form Message” screen 42 containing an alpha-numeric data sheet (see FIG. 4A). The “FIPR 12” button 44 (FIG. 4B) is clicked to access platoon-level information. The “FIPR” screen 46 (FIG. 4B, “Flash-0” tab activated) then provides access to a military “E-mail inbox” with platoon information 48 (e.g., “1/A/3-66AR”). Clicking the legend buttons 51 in the “Time”, “Msg Type”, or “Source Originator” columns provides a detailed alpha-numeric data sheet similar to “Long Form Message” screen 42 (FIG. 4A).

Field studies of graphical user interfaces using pop-up list/box type windows, such as provided by the FBCB2 interface (FIGS. 3A, 3B, 4A and 4B), indicate that commanders and their staffs can be inundated by the amount of data presented and the amount of effort required to interpret these data, particularly during combat situations when high stress and heavy workloads were imposed. A concrete example of these difficulties is illustrated by the activity sequence required to obtain the value of a combat resource (e.g., number of tanks) at the battalion level. The “F3 Combat Msgs” button 34 is activated from the Main Screen (FIG. 3A). A company button, such as for example tab 38D (e.g., “D/1-22”) is then activated in the Combat Messages screen 36 (FIG. 3B) and the corresponding Long Form Message screen 42 (FIG. 4A) then appears upon selection of a particular unit tab, such as for example tab 48 (FIG. 4B), in order to acquire specific unit information. The parameter value must be located in the alpha-numeric data and remembered. The entire process must be repeated for three more companies, followed by the computation of the final parameter value (either mentally or manually).

The RAPTOR interface, designed specifically to support direct perception and direct manipulation, provides far better interface resources for the completion of the task of obtaining friendly forces information and other such tasks than prior art graphical user interfaces, such as the FBCB2 interface. The battalion icon 10 (FIG. 2A) simply needs to be activated (i.e., clicked on) and moused-over (after it appeared on the map display) to view the computed parameter value (assuming the default configuration of the RAPTOR interface illustrated in FIG. 2A). It is to be appreciated that similar advantages are present with RAPTOR for different informational needs (e.g., the categorical status of tanks) and different echelon levels.

Experimental Study

In one experimental study, a qualitative simulation was conducted to portrayed realistic changes in combat resources at three time-periods during an offensive tactical scenario. Army personnel (6 Captain, 6 Sergeant First Class) volunteered to participate in the experimental study and were required to performed well-constrained, but critical tasks. Their military specialties were engineer, artillery, or armor (8-20 years of active-duty service) and they ranged from 30-41 years of age. No participants had previous experience with either interface. All participants had normal or corrected-normal visual acuity and color perception. Three types of assessments were administered with regard to the combat-readiness of friendly forces: quantitative (e.g., what is the numerical value of tanks in Company C?), categorical (e.g., what is the color-code status of fuel in the Battalion?), and needs (e.g., what platoon in Company B needs Bradleys?). Participants were also required to consider friendly forces at three different echelon levels (battalion, company, and platoon). These assessments are typical of the information-seeking activities that Army commanders would perform repeatedly during the course of tactical operations. As discussed hereafter, the RAPTOR interface improves overall performance of commanders in making command and control decisions.

All experimental events were controlled by identical computers (Apple Computer, Inc., Cupertino, Calif., G3-300 MHz), with identical color monitors (Dell Computer, Round Rock, Tex., Trinitron, 40.64 cm, 1024×768 resolution, model #D1025TM) and standard keyboards. Participants were also provided with note-paper, pen, and a calculator.

A simulated offensive tactical scenario was developed, based on exercises conducted at the Army's National Training Center. The battalion's mission was to traverse a pre-defined route, engage the enemy, defeat the enemy, establish a defensive position and prepare for a counter-attack. There were 4 companies in the battalion: Company A (10 tanks and 4 Bradleys), B (14 tanks), C (4 tanks and 14 Bradleys), and D (14 Bradleys). There were 3 platoons (1, 2, & 3) in each company (each with 4 tactical vehicles either all tanks or all Bradleys). The combat resources for each echelon level (battalion, company, and platoon) were considered at 3 different points in time: H-hour (onset of initial engagement), H+3 (3 hours later), and H+12 (12 hours later). The combat resources consisted of 5 combat readiness parameters: tanks, Bradleys, ammunition, fuel, and personnel. Three of these parameters (tanks, Bradleys, personnel) were computed as a simple percentage of the full complement. Ammunition was computed as the number of potential armored vehicle kills (all 120 mm rounds+all anti-tank missile rounds+the mm rounds/10). Fuel was computed as the unit range in kilometers (using the fuel economy of the M1 Tank).

The experimental FBCB2 interface was designed to replicate the visual appearance and selected functionality of this interface as it appeared in December, 2000. The experimental interface differed from the actual interface in three respects. First, tank and Bradley resources were separated. Second, fuel and ammunition were calculated as range and potential kills (instead of gallons and rounds, see above). Third, platoon-level data were simplified (only platoon status e-mail messages appeared) and more organized (listed in order of company/platoon, not in the order they were received). These changes were introduced to provide equivalent information, thereby making comparisons with the RAPTOR interface more meaningful.

Participants completed 4 sessions on successive days. In the training session (2-h) all participants received both written and oral descriptions of the simulation, interfaces and experimental tasks and completed a practice session using both interfaces. Participants then completed 1 experimental session (1-h) on each of 3 successive days. Each experimental session contained 6 blocks of trials formed by a factorial combination of the 2 interfaces and the 3 combat phases. The order of these 6 blocks was randomized.

Three types of questions were administered. A “quantitative assessment” question asked for the quantitative value of a combat readiness parameter (tanks, Bradleys, ammo, fuel, personnel) for a particular unit (e.g., what is the numerical value of tanks in Company C?). A “categorical assessment” question asked for the categorical code (e.g., Black, Red, Amber or Green) of a parameter for a particular unit (e.g., what is the color-code status of fuel in the Battalion?). A “needs assessment” question asked which of the various units at a particular level needed a particular resource (e.g., what platoon in Company B needs Bradleys?). The participants were instructed to respond as accurately and as quickly as possible; no discussion of specific strategies was provided.

A total of 18 trials were completed during a block of trials; each block consisted of 2 sets of 9 trials (a factorial combination of the 3 echelon levels and the 3 question types). The presentation order of the trials within a sub-block was randomized. The specific company (1 of 4) or platoon (1 of 12) and combat readiness parameter (1 of 5) that appeared in a question was chosen at random. Participants pointed and clicked on buttons (see FIG. 3A) to indicate their response. After each trial the participant was provided feedback on accuracy of their responses. Thus, participants completed 324 trials (18 trials in each of 6 blocks during 3 experimental sessions).

Results

FIGS. 5A and 5B are a tabulated empirical results, in which FIG. 5A are pre-planned, orthogonal contrasts conducted for interface and echelon level, including contrast weights, and FIG. 5B are F-values and significance levels for the pre-planned contrasts involving interface and for the tests of the simple main effects of interface (following a significant interaction). A shaded cell signifies performance advantages favoring the graphical user interface according to the present invention. The letters “ns” signify that a contrast was conducted, but the results were not significant at the 0.05 level.

FIGS. 6A, 6B, and 6C are a graphs of Mean levels of performance for all interface and echelon combinations, in which FIG. 6A is a quantitative assessment, FIG. 6B is a categorical assessment, and FIG. 6C is a needs assessment. Accuracy is plotted on the y-axis; latency is plotted on the x-axis. Note that better performance is located in the upper right portion of the graph. Filled and unfilled symbols identify means obtained with the RAPTOR interface and the FBCB2 interface, respectively. Square, circle, and triangle symbols identify means obtained for the battalion, company, and platoon echelon levels, respectively.

Accuracy scores were computed as correct or incorrect. Latency was measured from the appearance of a question until the initial response ( 1/20-s accuracy). Latency outliers were identified using the following prior art test: T1=(x(n)−x)/s, where x(n) is a particular observation (one of n observations), x is the mean of those observations, and s is the standard deviation of those observations. Accuracy scores associated with latency outliers were also not considered. The percentage of outlier scores was 2.24%, 1.62%, and 1.77% for the quantitative, categorical, and needs assessments, respectively. Non-parametric tests were conducted to assess the distribution of outliers across experimental conditions; none were significant. Remaining scores were averaged across battle phase, session, and repetition; a set of 5 pre-planned orthogonal contrasts were performed (see FIG. 5A). The results of the pre-planned contrasts involving interface are listed in FIG. 5B. Additional contrasts were performed to assess the simple main effects of interface when significant interface by echelon interaction contrasts (Contrasts 4 & 5) were obtained; the results are also listed in FIG. 5B. The interface and echelon interaction means for each of the three assessments are illustrated in FIGS. 6A, 6B, and 6C.

Discussion of Results

The pattern of results was clear and unequivocal; indicating that the RAPTOR interface was more effective than the FBCB2 interface. Five of the six contrasts testing the main effect of interface were significant (Contrast 1, FIG. 5B); there were seven significant interaction contrasts (Contrasts 4 and 5, FIG. 5B) and ten significant contrasts for the simple main effects of interface. Each of the statistical comparisons between interfaces that were significant indicated that performance with the RAPTOR interface was better than performance with the FBCB2 interface (these contrasts are highlighted with gray-scale shading in FIG. 5B; see also FIGS. 6A, 6B, and 6C). The superior performance of the RAPTOR interface was present in all assessment categories (quantitative, categorical, and needs), dependent variables (accuracy, latency), and echelon levels (battalion, company, platoon).

These results indicate very clearly that the RAPTOR interface provided better support for obtaining friendly combat resources than the FBCB2 interface. Specifically, overall performance was determined by the quality of mapping between three sources of constraints: those constraints contributed by the domain (the demands to be met), the agents (capabilities/limitations), and the interface (requirements introduced through design). The discussion to follow is organized around the principles of direct perception and manipulation.

The RAPTOR interface was specifically designed to support direct perception, as discussed in the introduction section. The content mappings (domain constraints <--> interface constraints) were effective: information from the various categories of the abstraction hierarchy were present in the interface, as were consistent summaries of combat resources at all relevant echelon levels. The format mappings (display constraints <--> agent constraints) were also effective. The graphical representations were carefully designed to reflect the inherent constraints of the domain information being represented (e.g., unique representations for each combat parameter) and to support information pick-up (e.g., categorical, analogical, and alpha-numeric visual information corresponding to assessment requirements). The constraints introduced by the RAPTOR interface allowed skill-based interaction: it decreased the amount of cognitive resources and mental effort required and allowed the agent to use powerful visual modes of attention to obtain information regarding friendly combat resources.

In contrast, the FBCB2 interface did not support direct perception effectively. The quality of the content mappings was poor. There was little regard for the categories of information that should be present in the interface (i.e., levels of the abstraction hierarchy). In addition, data regarding friendly combat resources were presented in piecemeal fashion (e.g., no summarization or integration across lower echelon levels). The quality of format mappings was equally ineffective. The primary form used to represent combat resources was alpha-numeric (i.e., the long-form messages) as opposed to graphical. This forces the agent to use limited cognitive resources (i.e., working memory) to derive information mentally. As a result, acquiring information with the FBCB2 interface requires extensive search (i.e., navigation through multiple screens to locate all of the relevant data) and extensive cognitive processing (maintaining and manipulating these data in limited-capacity working memory).

The RAPTOR interface also provides resources that support direct manipulation. A critical control function for a commander engaged in tactical operations is to change his/her span of attention to monitor progress and coordinate activities across the organizational hierarchy (i.e., battalion, company, and platoon). The commander needs to control the grain of resolution at which friendly forces are considered and to see these units in the context of the battlefield terrain. As explained previously above, the RAPTOR interface supports this need by providing icons that represent these real-life objects of interest (i.e., the 17 units of action) and their resources directly. These icons can be manipulated directly to change both the resolution (i.e., the various units of action) and the context (whether the icons appear on the battlefield terrain) of combat resource information. The surface appearance of the FBCB2 interface suggests that direct manipulation is present: the tabs, buttons, and fields are graphical objects that can be pointed at and clicked on. However, this surface appearance is misleading. The graphical representations of the real-life objects of interest (i.e., the unit symbols on the map display) cannot be manipulated directly: obtaining combat resource information involves indirect manipulation of the tabs, buttons, and fields. The lack of direct manipulation resources in the interface imposes inefficient action sequences. Changing the resolution of combat resource information (e.g., viewing the resources of a lower level unit) involves repeating the basic action sequence from scratch, as opposed to the context conditioned short-cuts enabled by RAPTOR (e.g., pointing and clicking a company icon on the map). Direct manipulation cannot be used to view combat resources in the battlefield context: the map is covered by the large display windows (see FIGS. 3 and 4). In summary, the FBCB2 interface may well qualify as a “graphical user interface,” however the manipulation that it supports is far from direct.

The results of the experimental study (FIGS. 5A, 5B, 6A, 6B, and 6C) indicate that the perception-action icons provide an effective solution for a critical challenge posed by one intermediate domain, military command and control. The perception-action icons in the RAPTOR interface permits highly efficient perceptual-motor skills to pick up the affordances presented in the space-time signals presented in the interface (direct perception of the icons) and to coordinate and synchronize execution of control functions for controlling the span of attention (direct manipulation of the icons).

As mentioned above, to achieve direct perception the two general needs that must be addressed are content mapping—the extent to which critical information in the domain of application is actually present in the display, and format mapping—the quality of the mappings between the constraints introduced by the graphical formats in the display (i.e., bar graph format vs. digital values) and the constraints introduced by the visual processing and visual attention capabilities of the commander. If the graphical formats in a display present the information using representations that allow a commander to obtain that information easily (i.e., the visual representations are consistent with the visual processing of the commander), then the quality of format mapping will be high (and vice-versa). This, in turn, provides affordances: these invariants will suggest other control actions embodiments that are appropriate, given the current context.

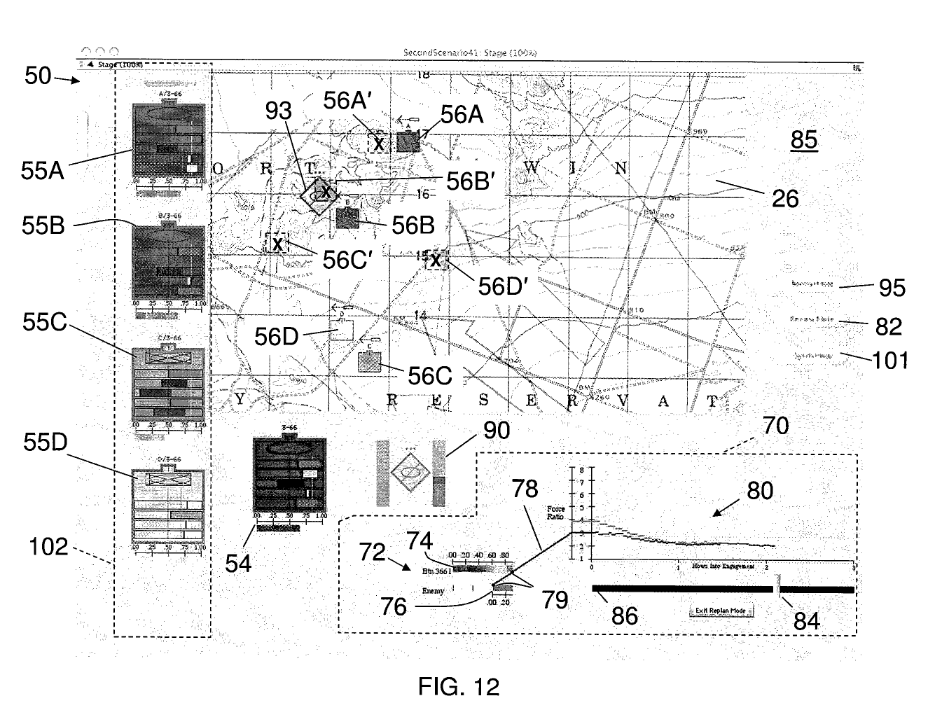

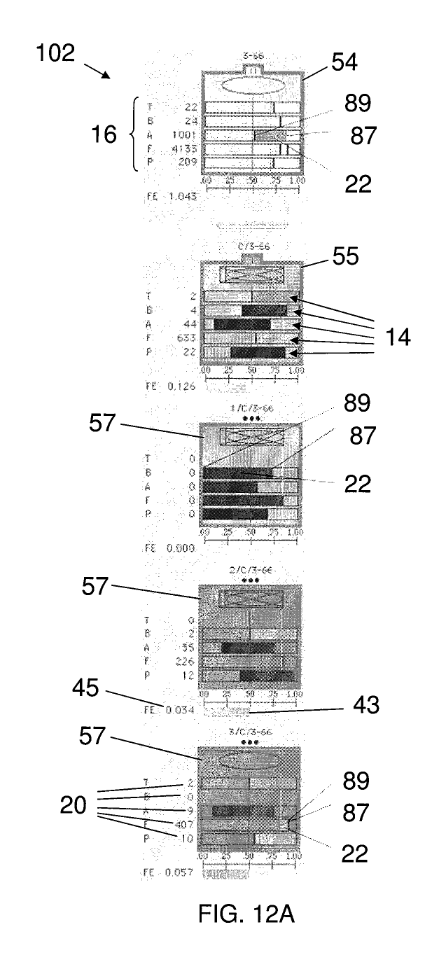

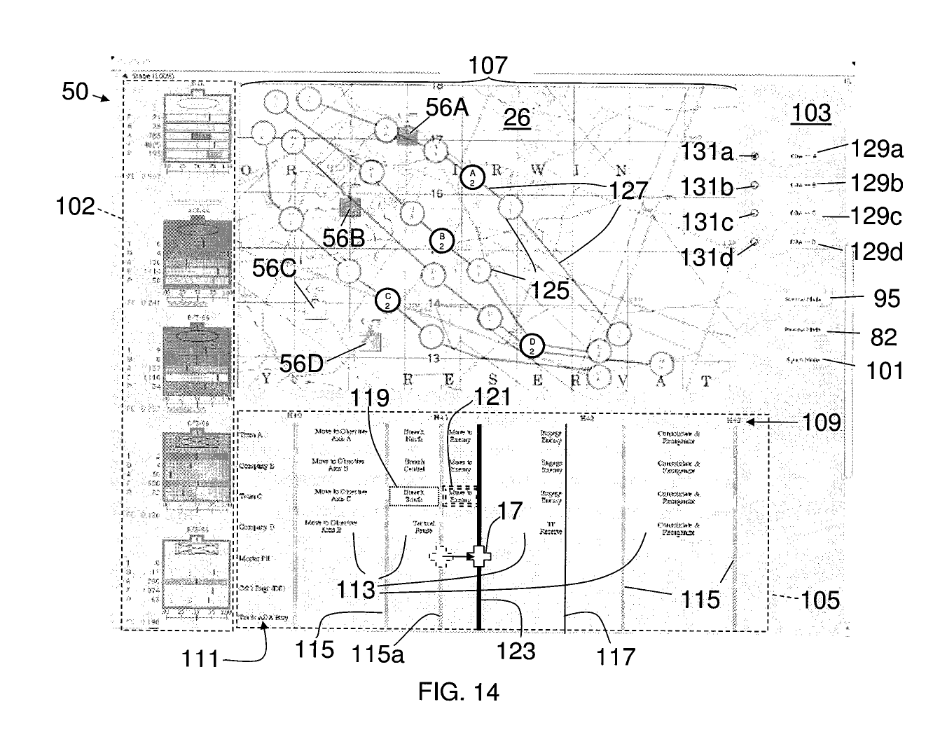

As disclosed hereafter in reference to FIGS. 7-13, embodiments of the RAPTOR (i.e., graphical user) interface are illustrated and generally indicated by symbol 50 in FIGS. 7 and 12. FIG. 7 represented a normal operational mode screen 52 of the RAPTOR interface 50 which provides a number of graphical representations: a friendly combat resources display section 53 with associated perception action icons; a force ratio display section 70 comprising a force equivalence display 72 and an associated force ratio trend display 80; an enemy combat resources display 90; and the map display 26 showing relationships of the units in the represented space. FIG. 12 represents a review mode screen 85, and FIG. 14 represents a synchronization mode screen 103, both of which will be discussed in greater details in later sections. These embodiments of the graphical formats allow the commander to perceive critical information directly using powerful visual perception skills (i.e., direct perception) as opposed to limited cognitive resources (working memory).

Friendly Combat Resources Display

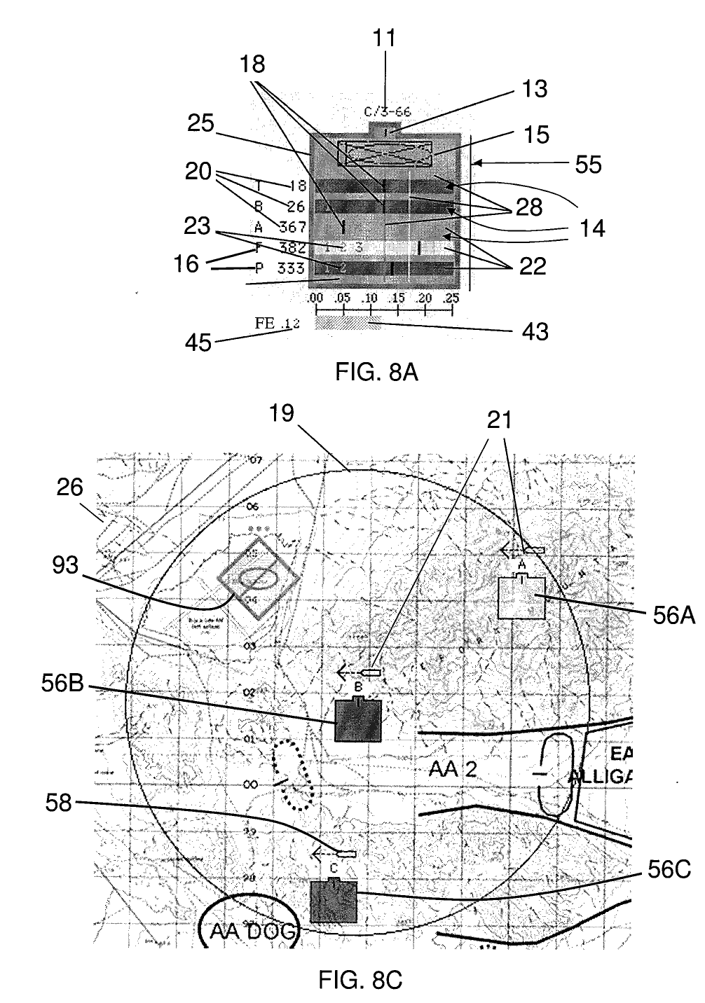

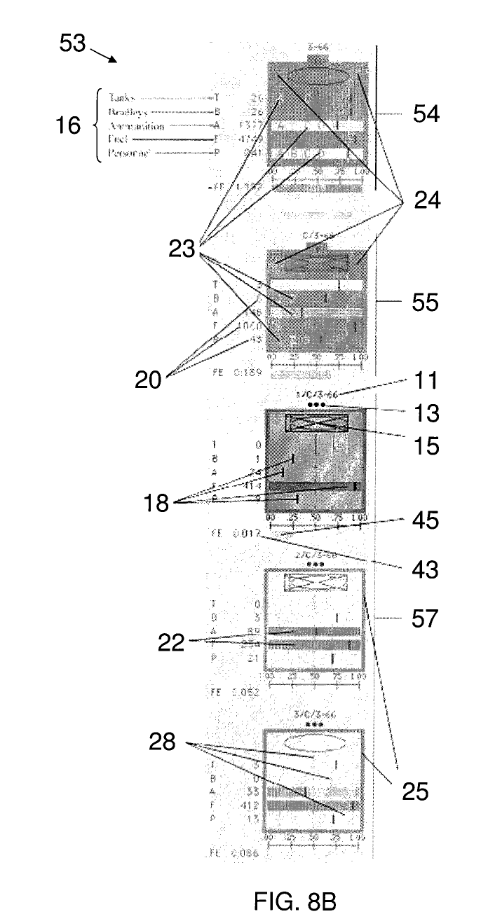

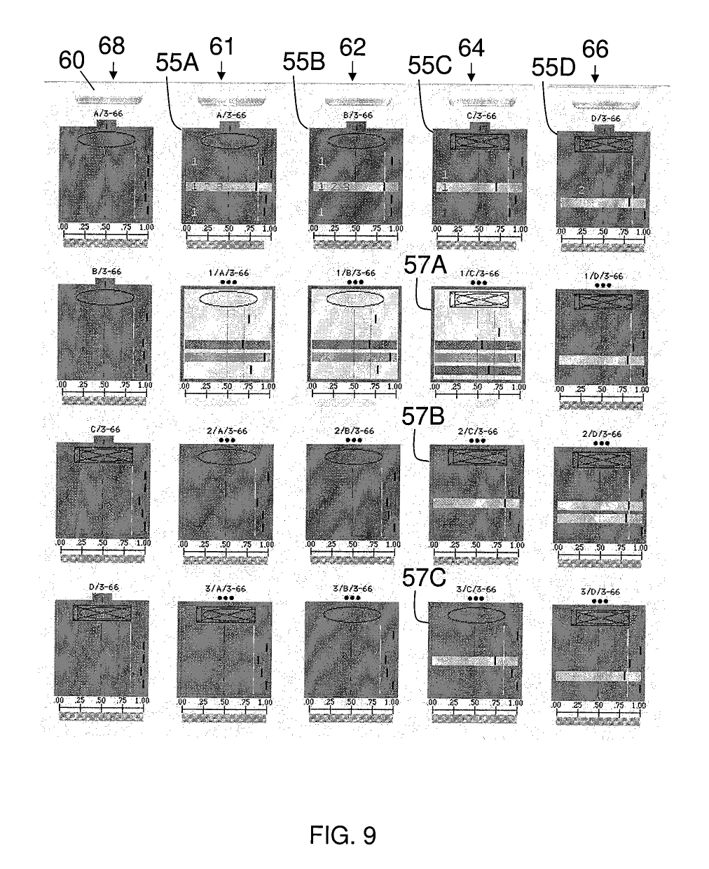

The friendly combat resources display section 53 provides a representation of friendly units at various echelon levels and their combat resources via four additional perception action icons embodiments: a battalion level perception action icon 54, a company level perception action icon 55, and a platoon level perception action icon 57. As shown by FIG. 7, for example, the depicted battalion 3-66, represented by perception action icon 54, is divided into four units at the next lower level (i.e., Company A, B, C, and D), which are represented by perception action icons 55A, 55B, 55C, and 55D (see also FIG. 9); and each company is divided into three units at the next lower level (i.e., Platoon 1, 2, and 3) which are represented by perception action icons 57A, 57B, and 57C. Regarding FIG. 9, it is to be appreciated that what is illustrated are successive views of the friendly combat resources area 53 that occur when the commander clicks on button 60, which allows quick access to all the various levels of information discussed earlier without having to display such icons on the screen at all times. Accordingly, the RAPTOR interface 50 permits a battalion commander to assess friendly resources at different levels: battalion, companies, and platoons, such as depicted by FIG. 8B. Second, the RAPTOR interface 50 permits the commander to review individual combat resources at each of these force levels. As mentioned above, there are five primary combat resources that must be tracked at each level: two types of combat vehicles (tanks and Bradley troop carriers), personnel, ammunition, and fuel. Third, the RAPTOR interface 50 permits the commander to change the focus of attention and track these resources at higher levels of aggregation. As mentioned previously above, the “force equivalence” is a high-level summary of the military force that each of the units possess. Accordingly, the RAPTOR interface 50 can continue to represent friendly units at various echelon levels and their combat resources in various other types of interfaces. As before with the development of the RAPTOR interface embodiments of FIGS. 1A, 1B, 2A, 2B, and 2C, two analytical tools (abstraction and aggregation) were used to organize the information to be included in the friendly combat resources display section 53.

The friendly combat resources display section 53 represents friendly resources from a variety of different conceptual perspectives (i.e., levels of abstraction) ranging from the goals to be achieved to the physical resources that are available to achieve those goals. Analytical modeling tools were used to identify information at different levels of abstraction. This framework ensures that the display contains information at all of the conceptual perspectives (i.e., levels of abstraction) that the commander will need to consider. Information that appears in the combat resources display section 53 at each level will be described in references to FIGS. 7-13.

The combat power (i.e., military force) that a unit can contribute to tactical operations resides at the level of abstract function and priority measures. A subset of combat power is force equivalence, an estimate based on the combined status of tanks and Bradleys. As before with the previous embodiments, for example, the tangible contributions to combat power are captured by five combat parameters: tanks, Bradleys (armored personnel carriers), ammunition, fuel, and personnel (T, B, A, F, and P, respectively). These combat parameters reside at the level of physical processes and activities. Other information at this level includes a unit's range arc (the weapons envelope of a unit's primary munition) and its identification, type, and size symbols. A unit's role in the current tactical operation is information that corresponds to the level of general functions and activities. Information at the lowest level of the abstraction hierarchy (physical form and configuration) includes the physical characteristics of the battlefield terrain and the physical location of a unit on this terrain.

The calculation of the combat parameter values that appeared in the friendly combat resources display involves several departures from conventional Army procedures. In the present invention, the individual combat parameters were calculated using non-standard formulas to provide the commander with more ecologically valid (i.e., meaningful) information about the potential for action (i.e., “affordances”) in the domain.

Normally the total number of tanks and Bradleys are reported as a single number. However, these two types of vehicles provide very different functional capabilities for tactical operations. Therefore, the resources for these two types of vehicles were reported individually in the combat resources display. Similarly, Army convention is to report fuel levels as gallons of gasoline. However, a more important consideration for tactical operations is the distance that the unit is capable of traversing. Fuel levels were therefore reported as the distance (in kilometers) that the unit could travel. The distance was calculated for an M1A1 vehicle (tank) by taking the gallons of gas in the vehicle and multiplying by its fuel economy (0.9228 Km/Gallon). The distance was calculated for an M2 vehicle (Bradley) by taking the gallons of gas in the vehicle and multiplying by its fuel economy (2.759 Km/Gallon). The number actually reported for a unit is the lowest number of kilometers that can be traversed by any of the vehicles in that unit.

Finally, ammunition levels are normally reported as the number and types of munitions that are available. However, the key consideration for the battalion commander is the number of armored vehicles that these munitions are capable of disabling. Therefore, ammunition was computed using the following formula: the number of 120 mm rounds (tank cannon) plus the number of anti-tank missile rounds (TOW's) plus the number of 25 mm machine gun rounds/10.

Perception Action Icon

With reference made to FIGS. 7 and 8A, the most critical information for friendly combat resources is the values of the five combat parameters (e.g., T, B, A, F, and P) that are listed in the rows of combat resource parameters 14 in this illustrative company level perception action icon 55 embodiment. There are two general representational forms that can be used to present the continuous variables that make up friendly combat resources: analog geometrical representations or indicators 18 and alpha-numeric representations (e.g., labels or legends 16, and digital values 20). Both have advantages and disadvantages; these advantages are complementary and both should be present in the interface.

There are two general options for an analog geometrical display format to portray the five combat resource parameters 14: 1) a configural display, where the five combat parameters are combined into a single geometric form (e.g., a pentagon), and 2) a separable display, where the five combat parameters have their own unique representation (e.g., 5 bar graphs). The proper design choice will be determined by the inherent relationships that exist between the combat parameters. In this case the combat resource parameters 14 have an independent, non-interactive relationship. As a result, a separable display format (i.e., individual bar graphs for each of the combat resource parameters 14) is the appropriate choice. A configural display, such as a pentagon geometrical form, would have produced visual interactions between variables that were meaningless and difficult to ignore.

The commander needs to consider friendly combat resources in different ways during tactical operations. In certain situations commanders will need only to “spot-check” or loosely monitor the value of a resource. In other situations the commanders will need more precise estimates that are still relatively easy to obtain. Commanders also need exact values for combat resources, such as provided by the digital values 20. Finally, commanders need to know how the resources at lower echelon units (e.g., platoons) vary with regard to the aggregated resources at a higher echelon (e.g., company). The combat resource display section 53 supports all of these information needs through the inclusion of three different types of visual indicators within each associated perception action icon 54, 55, and 57 that specify the value of each combat parameter in each unit.

The first visual indicator is the analog indicator 18 of the provided perception action icons, which represents the value of each parameter as a percentage of resources. This is calculated by taking the current value of a parameter (e.g., 3 tanks) and dividing by the maximum value (e.g., 4 tanks, for a value of 75%). The scale for each combat parameter (0% to 100%) is defined by the horizontal extent of the background parameter mat 22 (the colored, rectangular bars appearing inside each display). The distance from the left side of the background parameter mat 22 to the analog indicator 18 (short, vertical line) provides an analog visual representation of the percentage.

The analog indicators 18 support the commander in obtaining fairly accurate ball park estimates of the values of the individual resource parameters 14, the relationship with regard to categorical indicators (see below), and the relationships between parameters (i.e., the relative spatial positioning of the percentage indicators). This specific analogical form was chosen based on previous research indicating that horizontal extent from a common baseline is one of the most effective encodings for visual discriminations.

The second visual indicator represents the value of each parameter according to four mutually exclusive categories. The verbal labels and numeric ranges of these four categories are consistent with Army convention: Green: 100-85%, Amber: 84-70%, Red: 69-50%, and Black <49%. The percentage value for each combat parameter (see above) is located within the proper category. Each background mat 22 for a particular parameter is color-coded appropriately, and similar to those used in FIG. 1A. This categorical classification scheme (i.e., green: 100-85%) and the associated visual features in the display (color coding of the background parameter mat 22) were designed to allow general information (i.e., the overall categorical status) of a combat parameter to be perceived quickly and efficiently (i.e., “at a glance”). Note that there are visual indicators of the categorical boundaries 28 on the combat resource display in FIG. 8A. This allows easy visual comparisons between the value of an analog percentage indicator 18 and the categorical status indicated by mat 22 of a resource parameter 14 (i.e., “we're amber right now, but very close to red”).

The third visual indicator represents the exact value of each parameter as a digital value 20. As shown, the legend 16 provides a single-character label (e.g., “T” for tanks) next to the digital value 20 for each combat parameter 14. The digital value 20 reports the current value of a parameter (e.g., 3 tanks) rather than the percentage of resources (i.e., 75%-3 of 4 tanks). To avoid unnecessary clutter in the interface, these digital values 20 are not always present in the display; the commander can make them appear (i.e., highlight them) by positioning the cursor or mouse pointer over the desire perception action icon in the combat resource display section 53 or by positioning the mouse pointer over a matched unit icon that can be located on the battlefield map display 26 (i.e., the corresponding battlefield icon). The digital values 20 are included because commanders will occasionally need exact values of combat parameters 14 (e.g., when providing other personnel with “slant” reports).

An alphabetic (or numeric) indicator 23 for a lower-level unit's combat parameter may appear on a higher-level unit's combat parameter mat 22. This occurred when the categorical status of a combat parameter for a lower-level unit was not the same as the categorical status of a higher-level unit's. For example, the “1” and “2” that appear in the bottom parameter mat 22 of FIG. 8A indicate that the categorical status of personnel in platoons 1 and 2 is different from the categorical status of Company C as a whole. The exact nature of the differences are indicated by the contrasting color-code of the background parameter mat 22 (categorical status of the higher-level unit) and the color code of the alphabetic (or numeric) indicator 23 (categorical status of the lower-level unit). These various level indicators are easily seen in the combat resource display section 53 thereby providing a commander with a high-level visual indication that the combat resources of lower-level units (e.g., companies) are different from the summarized status at the next level up (e.g., battalion). It alerts the commander to surplus or deficiencies at lower levels.

There are three visual indicators (analogical, categorical, alpha-numeric) in each perception action icon of the combat resource display section 53 that inform the commander about the overall status of a unit. This status is calculated using “force equivalence” values. This force equivalence estimate is a critical subset of overall combat power. It represents the status of the fundamental contributors to military force: tanks and Bradleys. The force equivalence provides the commander with a “long-term” estimate of military force that is based on the status of large-scale equipment (i.e., tanks and Bradleys) which are difficult to reinforce.

The force equivalence estimates are unique, and were created in the following fashion. Estimates of force equivalence for “pure” battalions (containing only tanks or only Bradleys) were obtained from Army manual ST 100-3. The force equivalence estimate for an individual tank was then obtained by dividing this value by the number of tanks in the pure battalion. The same process was followed for Bradleys.

The real-time force equivalence of a unit used in the combat resources display section 53 is calculated in the following fashion. First, the surviving tanks in a unit are summed to obtain a total number; this value is multiplied by 0.0286 (force equivalence estimate of an individual tank). Second, the surviving Bradleys in a unit are summed to obtain a total number; this value is multiplied by 0.01724 (force equivalence estimate of an individual Bradley). These two numbers are then added together to provide the force equivalence estimate of the unit.

The first visual indicator for the force equivalence of a unit is an analog bar graph 43 on the bottom of each perception action icon (see FIG. 8A). The horizontal extent of this bar graph is determined by the force equivalence estimate for the unit. The second visual indicator for the force equivalence of a unit is an exact digital value 45 located to the left of the analog bar graph 43. The third visual indicator for the force equivalence of a unit is the background color code 24 of the unit's display based on an overall categorical rating that falls within one of the four categories outlined previously. This overall rating is determined by taking the current force equivalence value and dividing by the force equivalence value that represents full strength. The color of the analog bar graph 43 is also determined by this rating. Additional information about the unit that appears on the perception icon icons includes the alpha-numeric unit identification label 11, the graphical unit size symbol 13, and the graphical unit type symbol 15. These indicators are consistent with Army convention.

The color-coding of the display background 24 (categorical force equivalence for the unit) and the background parameter mat 22 (categorical status of combat parameters) supported easy visual comparisons. The commander needs to compare the status of the combat parameters within a unit to each other and to the overall status of that unit. For example, these comparisons would help in identifying reinforcement needs for the unit. Alternatively, the comparisons might be used to identify excess resources that might be used elsewhere to achieve other mission goals. The graphical format was designed to highlight these differences through the stark visual contrast between the color of the larger icon (i.e., over-all categorical status of the force equivalence of a unit) and the color code of the background parameter mattes for any of the combat parameters that are not at the same categorical status. The commander can pinpoint any discrepancies with a glance.

Combat Resource Display Section

The combat resources display section 53 was designed so that the visual salience (i.e., visual prominence) of the various components of the display reflected the relative importance of that component's information in domain terms. It should be easier to focus attention on the information that is most critical for decision making. The most critical piece of information (the overall force equivalence of a unit) is represented by the most salient visual feature in the graphical format (the background color code 24 of the unit's perception action icon). Information at an intermediate level of importance (individual combat parameters, their values and relationships) was presented through visual features (background parameter mats, analog percentage indicators, activity symbol) at an intermediate level of salience. For example, the analog percentage indicators 18 provide a more precise (but still reasonably easy to obtain) analog representation of the corresponding digital values 20. Basic information (e.g., unit's identification, size and type symbols 11, 13, and 15) is presented at the lowest level of visual salience. Finally, some information (a unit's munition range envelope 19, digital values of combat parameters 20) was only available when the mouse rolled over an icon, thereby providing access but avoiding clutter. The commander needs to be able to focus attention on the various components of the normal operational mode screen 52 of the RAPTOR interface 50 to facilitate extraction of the associated information.

Complementary Display: Battlefield Icon

In FIGS. 2A, 2B, and 2C, the perception action icons 10, 12, and 30 are provided overlaying and obstructing the terrain provided in the battlefield map display 26. However, in some situations the view of the battlefield terrain is a critical consideration during tactical operations. Accordingly, a complementary set of small, semi-transparent icons 56A, 56B, and 56C are provided by in the illustrated embodiment of the RAPTOR interface 50 in FIGS. 7 and 8C for placement on the battlefield map display 26. These icons 56A, 56B, and 56C are normally semi-transparent, allowing critical terrain features on the map display 26 to be seen. The size of these icons 56A, 56B, and 56C visually represent the echelon level (i.e., battalion, company, and platoon icons are progressively smaller). The location of the icons 56A, 56B, and 56C (specifically the lower left corner of the icon) represents the physical location of the unit on the battlefield map display 26. The color code of the icon 56A, 56B, and 56C represents the overall categorical status for the force equivalence of the unit. The unit's role in the current tactical operation is indicated through standard Army activity symbols 21. For example, in FIG. 8C the “arrow” provided to each icon 56A, 56B, and 56C represents that the battalion is in an offensive attack mission. Also, provided is the range envelope 19 specifying the weapons envelope for the unit's primary munition appears when the commander positions the cursor over an icon (e.g., 56B).

In the illustrative embodiment of FIG. 7, there is a one-to-one correspondence between the perception action icon 54, 55, and 57 of the combat resources display section 53 and the semi-transparent icons 56 displayed on the map display 26. However, to provide additional flexibility the presence of the two types of icon displays (i.e., perception action and semi-transparent) were controlled independently. If both types of icons for a particular unit are present in the main screen 52 of the RAPTOR interface 50, then a number of changes in visual appearance occur when the cursor is positioned over either of the displayed icons. Both of the displayed icons become more vivid in appearance (i.e., the normal “transparency” of the semi-transparent icon is reduced and/or eliminated) and the alpha-numeric labels 16 and digital values 20 appear on the combat resource display section 53 for the corresponding perception action icon. The two displayed icons revert to their normal appearance when the cursor is no longer positioned over one of the two icons.

As described in the previous sections, the embodiment of the RAPTOR interface 50 shown by FIGS. 7-13 achieves direct perception of friendly combat resources, and allows the individual units to be seen in the context of the battlefield. Direct manipulation allows control actions (in this case selecting the appropriate unit) to be executed through the selection and manipulation of the objects that are present in the interface. In addition, the embodiment of the RAPTOR interface shown by FIGS. 7-13 is designed to displays a subset of the seventeen displays at any point in time, and provides the user with the capability to cycle through the other remaining display subsets.

As illustrated in FIG. 7, there are always five perception action icons displayed in the combat resource display section 53 in the RAPTOR interface 52 at any point in time. The display of the task force icon 54 is always present and the remaining four icon displayed (55 and/or 57) can be changed as desired. The default display configuration presents the four units at the echelon level below the task force level: Companies A, B, C, and D. To obtain more detailed information at the platoon echelon level the user points and clicks the button 60 located over the column of the four icon displays. The first click eliminates the display in the combat resource display section 53 the Company B, C, and D icons 55B, 55C, 55D, respectively, and presents the three platoon level icons shown in column 61 of FIG. 9, which represent the platoons that constitute Company A (i.e., 1/A/3-66, 2/A/3-66, and 3/A/3-66). Another click replaces the four icons representing Company A and its platoons in the combat resource display section 53 of the RAPTOR interface 52 with the four Company B icons shown in column 62, and another click replaces the Company B icons with the Company C icons shown in column 64, and display the icons 55C, 57A, 57B, and 57C as shown in FIG. 7. A click with the four Company D icons shown in column 66 will cycle the interface back to the default configuration shown in column 68 as presented in FIG. 12.

As mentioned above, the RAPTOR interface 52 enables a commander to see friendly and enemy units arrayed on the map display 26 and to see the features of the terrain where the battle is unfolding. Pointing and clicking on any of the five perception action icons 55C, 57A, 57B, and 57C in the combat resource display section 53 will place a corresponding semi-transparent display on the map display 26 and will simultaneously remove any other semi-transparent displays that were present. Pointing and clicking on a semi-transparent display that appears on the map display 26 will remove that semi-transparent display and replace it with displays at the next-lower echelon level. For example, pointing and clicking on the task force semi-transparent icon will result in the removal of that display and the presentation of the four semi-transparent icons for Companies A, B, C, and D. Selection of the Company level semi-transparent icon will result in display of the platoon level icons, such as the platoons generally indicated by icons 56A, 56B, 56C, or 56D shown by FIG. 7.

Force Ratio Display Section

As described for the friendly combat resource display, force equivalence is a measure of the military power possessed by a unit. The relationship between friendly and enemy force equivalence is a higher-order property normally referred to as “force ratio.” In mathematical terms, the force ratio is a fraction: the force equivalence value of the larger force is used as the numerator (i.e., the number located above the line in a common fraction) and the force equivalence value of the smaller force serves as the denominator (i.e., the number located below the line).

Force ratio is an important consideration in tactical operations. The Army has developed guidelines for the amount of force equivalence that will be required to undertake particular kinds of tactical operations. For example, a unit considering an offensive attack against a well-fortified and dug-in enemy position needs approximately six times the amount of combat power than that possessed by the enemy. During the course of a tactical engagement the force ratio needs to be monitored to assess progress (or a lack of progress) towards goals. Thus, it is a critical piece of information that testifies with regard to decisions to continue or abort a mission.

Force Equivalence Display

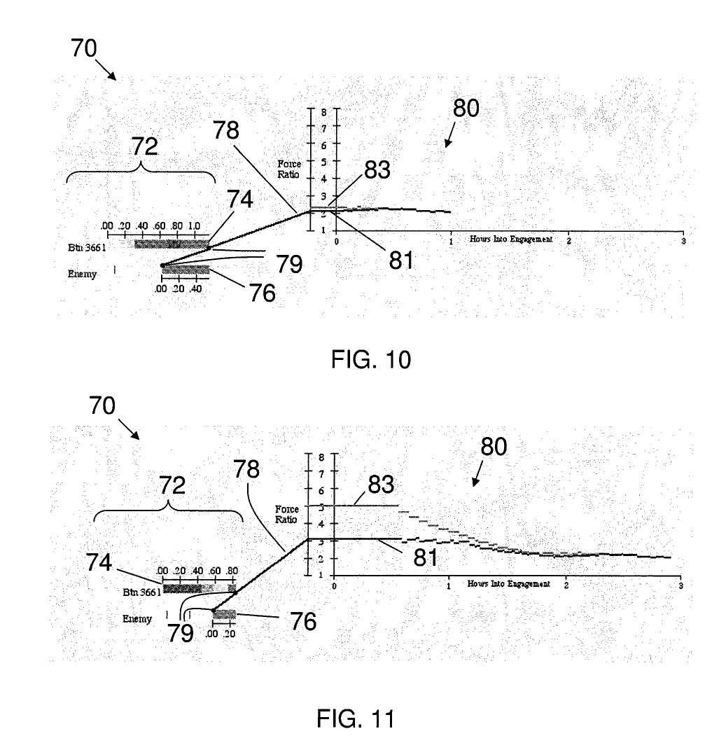

The force ratio display section 70 (best shown by FIGS. 10 and 11) illustrates the military power of friendly forces, enemy forces, and their relationship in real time. It is a fluctuating commodity whose value depends upon the flow of resources into (e.g., logistic reinforcements) and out of (e.g., resources expended during a tactile engagement) the system, and comprises the force equivalence display 72 and the force ratio trend display 80. The force equivalence display 72 in the lower, left-hand portion of the force ratio display section 70 represents the friendly and enemy force equivalence values. In the force equivalence display 72, the top bar graph 74 always represents the force equivalence that is the larger of the two. In other words, the larger military force is used as the numerator and the smaller force is used as the denominator. In the illustrative embodiment shown by FIG. 10, the friendly force (Btn 3661) has the larger force equivalence, which is approximately 1.2. The origin for the top bar graph 74 is located on the left hand side of the force equivalence display 72 and is labeled with the “0.00” that appears above the bar graph 74. An increase in force equivalence (e.g., reinforcement) is represented by an increase in the horizontal extent of the bar graph 74 from the left to the right (and vice versa). The lower bar graph 76 always represents the smaller of the two force equivalents (in this case the Enemy). The origin for the bar graph 76 is also located on the left and is labeled with the “0.00” that appears below the bar graph. Note that the right-most edges of these two bar graphs are always aligned.

The geometrical properties of force equivalence display 72 were designed to provide salient visual representations of a critical higher-order domain property:force ratio. The formula for force ratio is a simple fraction: the larger of the two force equivalents is divided by the smaller. The two bar graphs 74 and 76 were specifically chosen to provide the visual analog of a fraction. It is to be appreciated that each bar graph 74 and 76 is color coded and can indicate various color segments which represent the force equivalence contribution of each company making up the size of the bar graph. For example, if Company B was below 50% in total combat power strength and all the remaining companies (e.g., A, C, and D) were at full combat power strength, then the bar graph 74 would show a green portion, followed by a black portion, follow by two green portions. In addition, since the size of Company B is less then 50%, the scale of the force ratio also changes accordingly to indicate a loss in strength.

In addition, one set of emergent features specifying force ratio is the difference in the horizontal extent of the two bar graphs 74 and 76 from the common baseline. In FIG. 10, the force ratio is slightly more than two to one. The value of force ratio is made more explicit by “multiplication indicators” which are vertical line segments that can appear to the left of the lower bar graph 76 (to the right of the “Enemy” label in FIG. 10). In this case a single multiplication indicator provides the exact physical location where the value of the smaller force equivalence is double its current value. If the force ratio were greater than three to one, then additional multiplication indicators would appear. Accordingly, the color of the portions making up each bar graph 74 and 76 as well as the force ratio scale for each bar graph 74 and 76, thus change dynamically when the force equivalence status of each company is reported to the system.

The most salient emergent features of force ratio are associated with the line 78 that connects the two bar graphs 74 and 76. Line 78 begins at a point defined by the upper left corner of the bottom bar graph 76 and continues through a point defined by the lower right corner of the top bar graph 74. The orientation of line 78 is dynamic: as the force equivalence values change, the two bar graphs 74 and 76 push or pull the endpoints of the line 78 to change its orientation. Thus, the line 78 is anchored to the two bar graphs 74 and 76 at specific points, but will rotate around these points. This is visually emphasized by the circles representing “ball” joints 79 at these points. The line 78 continues past the top bar graph 74 until it intersects the Y axis of the force ratio trend display 80. The geometries of the force ratio trend display 80 are devised so that line 78 always intersects the Y axis at the precise point defined by the value of force ratio. Finally, the exact value of force ratio may be provided by a digital value at the bottom of the Y axis (not shown).

Force Ratio Trend Display

The force ratio trend display 80 (i.e., the large collection of graphics appearing in the right side of FIG. 11) provides two very important types of information regarding force ratio. First, it provides a historical trace of actual force ratio values 81 over the course of the tactical engagement. The current value of force ratio is specified at the intersection of the line 78 arriving from the force equivalence display 72 and the vertical axis labeled “Force Ratio.” This value is extended horizontally to the Y axis of the trend display. The label for this axis is “0” because it is the current time. The display is updated at regular intervals. During an update the entire historical trace moves slightly to the right; the new current value then added to fill the gap created on the left. As the X axis of the display indicates, this particular display represents the values of force ratio over a three-hour time frame. The values in FIG. 11 indicate that the engagement is approaching the length of 3 hours at this point.

The second type of information presented in the force ratio trend display 80 is an historical trace of planned force ratio values 83 as they are envisioned to change across the time frame of the engagement, which is represented on the X axis. The two historical traces that appear in the force ratio trend display 80 are dark gray and light gray in FIG. 11; it is to be appreciated that values 81 and 83 are actually color-coded in the RAPTOR interface 52. As described previously, the dark historical trace represents the actual force ratio values 81 as they actually unfolded during the course of the actual engagement. In contrast, the lighter historical trace represents the planned force ratio values 83 as they were envisioned to unfold during the pre-mission planning phase. Thus, the visual distance between the pairs of lines is a salient emergent feature that specifies a discrepancy from plan. In FIG. 11 the actual force ratio was initially the same as the planned force ratio, but became progressively lower than planned for the remainder of the engagement.

These two displays 72 and 80 in the force ratio display section 70 together provide information regarding force ratio that should contribute to more effective decision support. The force equivalence display 72 provides a number of visual properties that specify the absolute value of force equivalence for friendly and enemy forces (i.e., the bar graphs in isolation). It also provides a number of visual properties that specify the relationship between these values of force equivalence (horizontal extent of the two bar graphs, multiplication indicator, orientation of the line, intersection location on the axis, digital value). This supports the commander in obtaining approximate, more detailed, or exact values of this domain property. In essence, the force equivalence display 72 provides not only the value of force ratio, but a graphical visual description of the underlying causal factors that combine to produce the value. The force ratio trend display 80 provides support at a slightly higher level. The commander can monitor the progress of the engagement with regard to force ratio via the force ratio display section 70. The emergent features in the display will alert the commander with regard to overall discrepancies of actual combat power from planned combat power as they develop.

Plan Review Mode

Several field studies of planning and re-planning with Army commanders indicated that Army commanders are not only concerned with understanding the current battlefield situation, they are also concerned with how the current battlefield situation relates to the plans that were devised for the engagement. Commanders and their staff develop detailed operational plans and alternative courses of action prior to tactical operations. These plans are fairly specific and comprehensive. For example, the plan may include goals to be at a specific geographic location at a specific time, to have secured a specific military objective, and to have done so with a specific expenditure of combat resources. The problem is that plans often need to be changed and adjusted. This is obviously the case when it is taking more time, resources, and effort to achieve an objective than it was originally planned. It is equally important to note that plans could need to be revised in the face of unexpected success as well.

To assist the commander in determining how well the actual battle is progressing relative to these plans, a plan review mode is provided in the RAPTOR interface 52. The plan review mode tracks both the commander's plan as it was intended to be executed and the actual progress that has been made in the battlefield. Accordingly, the plan review mode facilitates a commander's capability to determine when progress and resource expenditures have deviated (either positively or negatively) from a predetermined plan.

The commander enters the plan review mode by pointing and clicking on the “Enter Review Mode” button 82 in the interface (lower left-hand corner in FIG. 7). The visible changes that result are illustrated in FIG. 12. To obtain a detailed understanding of exactly how actual events have deviated from plan, a graphical slider 84 is provided in this mode under the force ratio trend display 80, and will be presented to correspond to the current time. For example, in the situation depicted in FIG. 12 the battle has been underway for approximately 2 hours.

The commander manipulates the slider 84 by pointing at, clicking on and dragging it along the horizontal length of the track 86. The length of the track 86 corresponds to the temporal duration of the tactical operation; manipulation of the slider along this track changes the time frame of the data that are presented in the displays. Locating the slider 84 to the left of the track presents data from the beginning of the mission. Locating the slider 84 to the right of the track presents data from the end of the mission. If the data to be presented have occurred prior to the current time, then both planned and actual information will be presented. If the data to be presented are in the future, then no actual information will exist to be presented. Thus, the planned data will change but the actual information will remain constant (i.e., current data will always be portrayed in any future times).

A number of changes will occur in the displayed information when the plan review mode is entered. A matched semi-transparent display 56A′, 56B′, 56C′, and 56D′will become visible for any semi-transparent icon 56A, 56B, 56C, and 56D that is located on the terrain map. In one embodiment, the matched semi-transparent display 56A′, 56B′, 56C′, and 56D′ with contain a black “X” to differentiate them from the actual semi-transparent icon 56A, 56B, 56C, and 56D. Each new semi-transparent display represents the physical location and categorical strength of a unit as it should appear at a particular point in time if the mission was going according to plan. Differences in color or physical location on the map between two matched icons therefore indicate deviance from plan. For example, using the plan review mode shows that Company C (unit 56C) and Company D (unit 56D) at approximately hour 2 are not located where they should be according to plan, which is illustrated by the semi-transparent dashed units 56C′ and 56D′. The plan review mode may also show via perception action icon 55C provided on the left hand side of the display 52 that Company C is at a lower categorical status (black) than planned (red) at hour 2. Such a situation may occur, for example, if Company C has encountered a heavier force than anticipated which required Company D's reinforcement, which explains the unplanned movement and progress of Companies C and D.

The force level perception action icon 54 and the four company level perception action icons 55A, 55B, 55C, and 55D, which are displayed off the map display 26 in the resource display section 53, also changes when entering review mode and with the movement of the slider 84. In review mode, the visual information presented in the review mode resource display section 102 now illustrates a range of values, rather than a single value for each combat parameter. As shown by FIG. 12A, the range for a resource parameter 14 in the review mode resource display section 102 is specified by the difference between a planned value 87 and the actual value 89. The visual representation of this range is always color-coded according to the categorical status of the actual parameter. For example, in FIG. 12A, Platoon 3/C's display indicates that for fuel the planned value 87 was approximately 80% (amber categorical status) while the actual value 89 was approximately 90% (green categorical status). This is captured in the green filled rectangle (right corresponding with actual value 89) with the amber line at the left (planned value 87). This results in a direct specification of the amount and direction of deviation from plan for all combat resource parameters 14 in the review mode resource display section 102. For example, the presence of large black and red rectangles in the review mode resource display section 102 shown FIG. 12A would be a very clear and prominent indication that Company C and its platoons are doing far worse than planned. The actual digital value 20 is also provided on the left hand side for each resource category 14. Finally, the force equivalence visual objects 43 and 45 in each of the perception action icons 54, 55, and 57 in the review mode resource display section 102 are updated according to the data from the appropriate time frame as the slider 84 is moved.

Tracking (and representing) the plan and the execution along dimensions (i.e., combat power, terrain, time, etc.) will highlight the difference between them. This should facilitate the commander's capability to recognize that there is a discrepancy that requires re-planning. Commanders will be alerted to the fact that the battle is deviating from plan earlier in the engagement, and will therefore be more pro-active in adapting plans to meet the particular needs of the present context. The information in RAPTOR interface 52, as well as the manner in which it is presented, will subsequently support the re-planning efforts that occur. The commander will knowing exactly what he/she has in terms of resources, where and how the actual battle deviated from the original plan, etc.

Enemy Resources Icon

The statuses of key enemy combat resources are equally as important as friendly combat resources during tactical operations. However, information regarding these resources will obviously be more difficult to obtain and the detailed representations that are used for friendly combat resources will not be appropriate. Generally speaking, intelligence is gathered to identify the size and the nature of the units that are likely to be opposing friendly forces during a particular tactical engagement. The primary concern is with lethal equipment (i.e., tanks and personnel carriers) and the end result is the “templated” number of each type of equipment that is likely to be involved during a particular engagement. During the engagement there are essentially three estimates of enemy equipment that a commander is likely to track: 1) vehicles that have been sighted or otherwise identified that have the capability to inflict battle damage on friendly forces (Alive or “A”), 2) vehicles that were identified and subsequently eliminated (Disabled or “D”), and 3) those vehicles that remain undetected but are likely to be present based on the intelligence template (Templated or “T”).

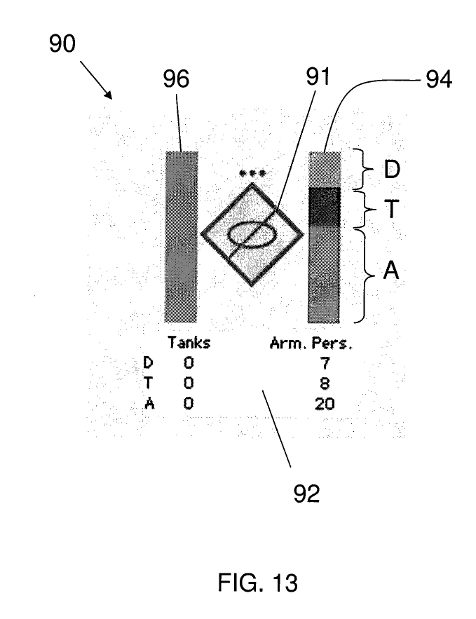

FIGS. 7, 12, and 13 shows one illustrated embodiment of enemy combat resources perception action icon 90. As best shown by FIG. 13, the size and composition of the enemy unit are identified using standard army symbology 91 (three dots indicating the unit size 97 and the symbol 99 the unit type). A corresponding semi-transparent enemy unit display 93 is also provided the map display 26. The columns in an information box 92 represent the three types of information that were outlined in the previous paragraph. The information regarding the heavy equipment counts of the enemy is represented separately by the left (tanks) and the right (armored personnel carriers) vertical columns. In the situation depicted in FIG. 13 the digital values in the information box 92 (these appear during a mouse-over) indicate that a total of 27 personnel carriers have been identified; 7 of these have been disabled (D) and 20 carriers are alive and dangerous (A). The digital values in the information box 92 also indicate that an additional 8 carriers should be somewhere in the combat area, based on the intelligence template (T). The size of the three rectangles (D, T, A) that appear in the column 94 provide a spatial analog for each of these values; the color code of the rectangle serves as a visual reminder of the category. Column 96 represents the values for Tanks, which is null. The disabled category appears as the top rectangle (dark gray), the templated category appears as the middle rectangle (dull red), and the alive category appears as the bottom rectangle (bright red). In FIG. 13 the digital values in the information box 92 for the number of tanks in each category is 0 and the color codes are dark gray (the column appears a uniform color). This indicates that the unit had no tanks to begin with. If there were tanks in the unit, column 96 would behave as the same manner as that described for the right column 94.

Synchronization Mode

It is to be appreciated that the RAPTOR interface 50 in one embodiment has three modes of operation. The first mode is the normal operational mode, which is shown in the main screen 52, and is selected from any other mode via the normal mode button 95. The other mode is the review mode as explained above, which is selected by review mode button 82, which displays the review mode screen 85 (FIG. 12) in the RAPTOR interface 50. Another mode that the RAPTOR interface 50 can assume is referred to as a synchronization mode. The operator enters this mode by pressing the “Synch” button 101 provided on the normal operational mode screen 52 (FIG. 7) or the review mode screen 85 (FIG. 12). One embodiment of a synchronization mode screen 103 of the RAPTOR interface 50 is depicted by FIG. 14.

Our domain analyses revealed that there are substantial requirements to coordinate and synchronize activities between team members during tactical engagements. Simply put, there is a need to coordinate team activities both temporally (i.e., so that the events occur at the same time) and spatially (i.e., so that the events occur at the same place). Normally these synchronization requirements are described in an alpha-numeric table referred to as a “synchronization matrix.” However, this textual representation of synchronization demands requires a great deal of cognitive effort and fails to capitalize on the potential provided by graphic displays. In FIG. 14, the synchronization mode display 103 of the RAPTOR interface 50 provides a set of two coordinated displays that represent this information graphically, a temporal synchronization matrix display 105, and a spatial synchronization matrix display 107. Each display 105 and 107 represents the same elements of the mission scenario, but emphasizes a different perspective.

Temporal Synchronization Matrix Display

The temporal synchronization matrix display 105 explicitly illustrates the temporal aspects of synchronization requirements in mission plans. Time 109 forms the horizontal axis of the matrix display 105, ranging from the initiation of the engagement (H+0) to three hours after the initiation of the engagement (H+3). The vertical axis of the matrix is partitioned into the separate units involved in the tactical operation, as indicated by operation labels 111 in the left-most column (e.g., Company B). A row in the matrix graphically illustrates a sequence of activity segments 113 (e.g., Move to Objective Axis, Breach North, Move to Enemy, Engage Enemy, etc.) that are planned for each unit and the amount of time 109 that each activity segment 113 should take. In addition, synchronization points 115 in time where there is a requirement to coordinate the activities of these units are illustrated graphically by the thick gray lines that run vertically through the matrix display 105. Current time 117 is illustrated by a thin black vertical line, which in the illustrated embodiment, the tactical engagement is approaching its second hour.

Visual changes in the matrix display 105 indicate the status of various activities 113 with regard to their associated synchronization points 115. Any type of visual change (e.g., change in background color, flashing, etc.) may be used to indicate status. For example, a visual change, such for example, the presentation of a border 119 around Team C's activity of “Breach South” indicates that this unit is in danger of not completing this activity on time. Similarly, the presentation of a double border 121 of their activity “Move to Enemy” indicates that this unit will not complete the activity on time. These status reports could be either submitted by the units or automatically generated based on constraints associated with the activity (e.g., a unit cannot travel fast enough to reach the destination by the designated time). The temporal synchronization matrix display 105 serves double duty since it is also a control. The visual representations of the synchronization points 115 can be manipulated directly to adjust the timing of activities. For example, if one unit is lagging behind and is clearly not going to make a synchronization point 115 on time, the commander can click and select the graphical representation of the synchronization point (i.e., the thick gray lines that run vertically through the matrix display 105) and drag it forward in time as illustrated by the thicker black line 123. In effect, this action would constitute a fairly minor modification of an existing plan that would be visible in the shared displays 105 and 107, and which would also be broadcast to the associated units as a command.

Spatial Synchronization Matrix Display

The spatial synchronization matrix display 107 explicitly illustrates the spatial aspects of synchronization requirements in mission plans. In the spatial synchronization matrix display 107, the mission plans are graphically represented by linked labeled circles 125 on the battlefield map display 26. Each circle 125 represents the physical spot that a unit needs to locate at to achieve a synchronization point 115. The letter inside each circle 125 indicates the unit; the number refers to successive synchronization points 115. The planned spatial route for each unit in the mission is provided by links 127 (which represent graphically the activity segments 113) that connect the labeled circles 125 (which represent graphically the synchronization points 115). Icons for the actual position of each unit at the current time 117, such as for example, semi-transparent icons 56A, 56B, 56C, and 56D, are also provided in the spatial synchronization matrix display 107, which allow comparison of actual position with reference to the objectives, path, and timing of the displayed mission plan represented graphically by the labeled circles 125 and links 127.

It is to be appreciated that the synchronization points 115 and activity segments 113 can also be dynamically changed on the spatial synchronization matrix display 107 during an engagement through direct manipulation (i.e., point, click, and drag) by the commander. Locating the mouse over one of the two displays will produce visual roll-over effects in the associated symbol in the other display. For example, if the operator places the mouse pointer 17 over synchronization point 115a in the temporal synchronization matrix display 105, the corresponding labeled circles 125 regarding that synchronization point 115a is highlighted in the spatial synchronization matrix display 107, which is indicated by the darker labeled circles 125 (i.e., circles with number 2 therein), and vice versa.

Pre-Planned, Alternative Courses of Action Displays

In the RAPTOR interface 50, the force ratio display section 70 in the normal operational mode screen 52 (FIG. 7) provides an overall indication that the course of the engagement is deviating from the mission plan. The review mode screen 85 (FIG. 12) provides an explicit illustration of the sources of that deviation. The spatial and temporal synchronization matrix displays 105 and 107 of the synchronization mode screen 103 offer ways to modify the current plan. At some point, however, an operator may want to review preplanned, alternative courses of action (COA's) and perhaps switch to one of these alternatives. The RAPTOR interface 50 provides these capability through COA display buttons 129a-d. The presently selected COA is represented in both the spatial and temporal matrix displays 105 and 107 when the synchronization mode screen 103 is entered, which in the illustrated embodiment is represented by selection of a radio button for COA-A 129a.

Clicking on one of the buttons 129a-d results in an alternative COA replacing the current COA in both the temporal and spatial matrix displays 105 and 107. Elements of the newly selected COA that are different from the previous COA will be highlighted (e.g., the links 127 and labeled circles 125 in the currently selected COA that are different from the previous COA will appear in red). The operator could review all of the pre-planned COA's by alternatively clicking on the different COA display buttons 129a-d in the synchronization mode display 103 of the RAPTOR interface 50. If a commander decides that an alternative course of action is more appropriate, then this decision could be communicated by clicking on an associated “radio” buttons 131a-d that appear to the left of the COA display buttons 129a-d. For example, of the operator has clicked the radio button for COA B plan, a message is issued to associated units and higher-level command indicating that the original COA A plan is no longer in effect (i.e., the radio button 131a for COA display button 129a is deselected) and that it had been supplanted by the new COA B plan (i.e., the radio button 131b for COA display button 129b is selected).

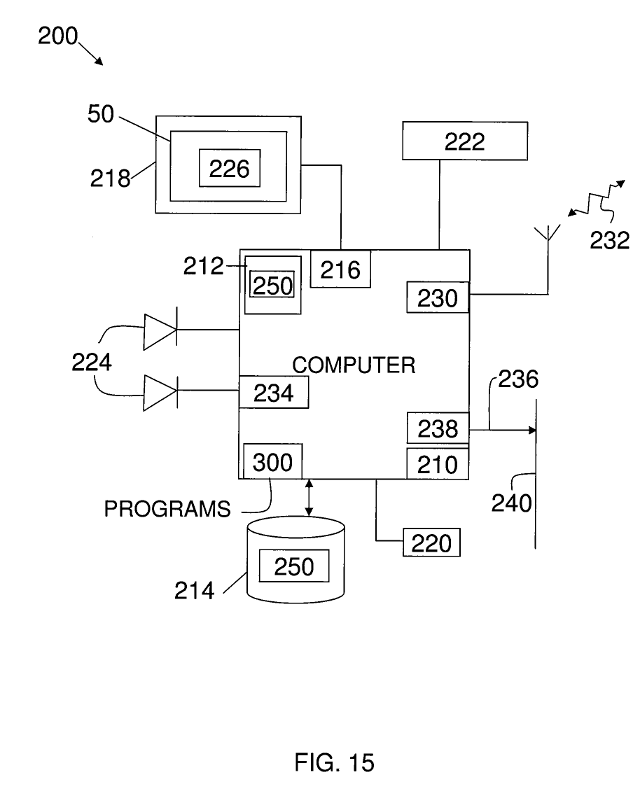

In one embodiment, the RAPTOR interface 50 of the present invention operates on a laptop sized computer located inside a command and control vehicle, and is used as a near-real time resource deployment decision analysis tool. In this configuration, the present invention is sufficiently comprehensive to provide a commander with the information that is needed to support decision making, wherein the visual representations allow the commander to literally “see” the information directly, rather than “deducing” it. For example, a system embodiment is schematically represented in a block diagram in FIG. 15. The present invention is capable of running as a program 300 on any general purpose computer system. A computer system 200 comprises a central processing unit (CPU) 210, random access memory 212, memory storage device 214, a graphical interface 216, a monitor 218, a selection device 220 such as a mouse, keyboard 222, and audio input/output capability 224, such as a microphone and speakers. The mouse 220 may be used to select visual objects 226 on the monitor, like the icons 10, 12, 29, 30, 54, 55, 56, and 57, and other objects (buttons, sliders, lines, links, circles, etc.) presented in displays/display sections 26, 53, 70, 72, 80, 90, 102, 105 and 107 of the RAPTOR interface 50 described above. The monitor 218 can be controlled and interfaced to the CPU 210 by the graphic card 216. The computer system 200 also has a wireless network card 230 to transmit and receive wireless network signals 232, such as updates to data 250 contained in memory 212 and/or 214 upon which the RAPTOR interface 50 uses to represent visually in the various screen modes 52, 85, and 103. In addition, speech synthesis or speech recognition 234 may be provided. The CPU 210 can also be connected 236 via a network adaptor 238 to a network 240. As systems that can be used to display graphical images, like icons and windows are well known, no further discussion is provided.

Conclusions

As provided by the above discussion, it is to be appreciated that the icons 10, 12, 29, 30, 54, 55, 56, and 57, displays/display sections 26, 53, 70, 72, 80, 90, 102, 105 and 107, and mode screens 52, 85, and 103 of the RAPTOR interface 50 allow information that is critical to the success of tactical operations (e.g., high level estimates of friendly and enemy combat resources) to be obtained easily. In essence the graphical formats of the icons, displays and mode screens in the illustrated embodiments are designed so that a commander can literally “see” and “perceive” critical information, rather than laboriously constructing it inside his/her head; it allows the commander to utilize powerful perceptual motor skills to obtain the status of mission-critical information. The icons, displays and mode screens of the present invention achieve effective content mappings, including information content from the various conceptual perspectives (i.e., categories of the abstraction and aggregation hierarchies) and consistent summarization of important resources at all levels in an organizational structure. The present invention also achieves effective format mappings: the representations matched the visual processing and visual attention characteristics of the operator (e.g., a military commander). As a result, in the illustrated embodiments (i.e., the friendly combat resources display, the perception action and semi-transparent icons, the enemy combat resources display, the force ratio and trend displays, the spatial and temporal synchronization displays, and the course of action displays) support the “direct perception” of information that is critical for successful tactical operations.

It should be noted that real tactical operations are characterized by high degrees of stress and high levels of fatigue. As noted above, the friendly combat resources display was designed to take advantage of the powerful perceptual skills of a military commander. Perceptual skills are far less prone to degradation under periods of high stress and fatigue than the cognitive skills (e.g., working memory) that are required by displays of other prior art graphical user interfaces. The present invention improves the capability of military commanders to understand the status and capabilities of the troops, the resources they control and the deviations from mission plans. The present invention also provides commanders more effective re-planning decision support during tactical operations. Accordingly, the present invention can contribute to better decision-making during tactical operations.

It is to be appreciated that the core ideas behind the RAPTOR interface 50 are applicable not only to military forces in general, but can have wide potential commercialization with modifications. For example, components of the RAPTOR interface 50 may be integrating into command and control systems having resource and planning displays. Furthermore, it is to be appreciated that the perception-action icons design strategy of the present invention can be generalize beyond the context of military command and control described in the above illustrated embodiments. This strategy is a hybrid solution that adapts and draws selectively from general strategies developed for domains located at the ends of the continuum.

In other such embodiments, the perception-action icons design strategy will be compared and contrasted to these general strategies so that its defining characteristics are clear. The factors that contribute to the success of this design strategy for the current intermediate domain (i.e., military command and control) are described. Another intermediate domain and the potential utility of the perception action design strategy are then considered. The constraints in law-driven domains have a high degree of regularity that facilitates analysis and modeling; the design activity involves the mapping of domain constraints into analog geometric representations that provide concrete spatial analogies. Configurable displays can be particularly useful in this role, at least when designed properly: they will produce higher-level visual features (e.g., closure, symmetry, parallelism) and dynamic behaviors that accurately reflect domain constraints. The interface constraints that are imposed by this design strategy are well-mapped to powerful skill-based behaviors of the human agent (e.g., the pick-up of visual information). The human agent can “see” system states and potential solutions, rather than deducing them. Note that the domain constraints are inherently complex; therefore, the visual analogies will also be rich and complex. Thus, the success of this design strategy relies upon a knowledgeable and experienced human agent.

In intent-driven domains there is less regularity in the constraints of the domain and therefore the agents' intentions and goals play a larger role in the unfolding interaction. These users will typically have far more diverse sets of knowledge about the domain, more diverse sets of computer skills, and less extensive experience with the decision support system. The use of spatial metaphors in the interface can relate the requirements for interaction to more familiar objects and activities, thereby leveraging pre-existing concepts and knowledge. The interaction requirements are related to familiar activities: the agent navigates through an over-arching spatial metaphor (i.e., a virtual library) to select subsets of books (i.e., enter a different wing of the library) and to execute different search strategies (i.e., enter a different room). Similarly, specific search terms are specified through the direct manipulation of icons with spatial metaphors that “suggest” the search term through an associative link to pre-existing concepts in semantic memory. Thus, the icons provide affordances and serve as signs that represent the various actions that can be executed.

The perception-action icons design strategy draws selectively from these two categories, adapting the details to the context presented by military command and control. First the overlap with the design strategy for intent-driven domains will be considered. The extensive use of icons to facilitate interaction is a key feature of both design strategies. In both cases the icons present affordances and serve as signs for actions that can be taken; the icons can be manipulated directly to execute these control inputs. A key difference lies in the visual representations that are used in these icons. The icons for intent-driven domains use metaphorical representations that relate interaction requirements to more familiar concepts and activities (e.g., the desktop metaphor). In contrast, the icons of the RAPTOR interface contain a variety of representations (geometrical, categorical, symbolic, alpha-numeric) that are designed to convey specific and detailed information about the domain (e.g., the friendly combat resources display depicted in FIGS. 1a and 8A). A unit's combat resources are the tangible contributors to the overall combat power of the unit; the value of these continuous variables must be conveyed directly, not metaphorically. The overlap with law-driven domains is probably best represented by the force ratio and trend displays (e.g., FIGS. 10 and 11). Here the analog geometric forms represent the underlying laws or constraints of the domain.

More fundamentally, the need for the perception-action icons design strategy appears to arise from the defining characteristics of the objects of interest in the domain of military command and control. First consider the objects of interest at the two endpoints of the continuum: the objects for intent-driven domains are essentially independent and loosely-coupled (e.g., books of fiction); the objects for law-driven domains are highly dependent and tightly-coupled (e.g., mass balance, energy balance). The objects of interest in military command and control (in this case, the various units of action) possess both of these qualities. The units are clearly dependent and coupled (e.g., organizational structure; coordinated mission goals), unlike the objects of interest in intent-driven domains. At the same time, they also possess a potentially high degree of independence (e.g., independent resources; independent mission roles), unlike the objects in law-driven domains. The perception-action icons design strategy is successful because it supports these dual needs. Information regarding combat resources can be obtained collectively or individually through the direct perception of the icons that correspond to the 17 units of action constituting the organizational structure of the battalion. Direct manipulation of these icons allows the combat resources to be considered at the proper grain of resolution and context for assessing progress towards collective or individual mission goals.

The perception-action icons design strategy is likely to be successful for other intermediate domains to the extent that the objects of interest in these domains share the defining characteristics outlined above. Another intermediate domain will be examined in greater detail to explore this possibility. Flexible manufacturing qualifies as an intermediate domain, primarily due to the incorporation of “just-in-time” production strategies that require substantial discretion on the part of the operator. Several categories of products are manufactured; each category is associated with a different set of manufacturing constraints. These constraints include the number and type of machining operations, the temporal sequencing of these operations, and the amount of time that is required. There are a limited number of configurable machining cells that can be used to perform the various operations. There is also an automated scheduler. However, the automated scheduler is not always capable of producing an acceptable solution due to the complex space of manufacturing possibilities (including inventory). Therefore operator intervention is often required. In summary, there are collective system goals with regard to both the category and the number of products that need to be produced within a particular time frame. Meeting these goals, however, requires the consideration of individual products: the number, type and sequencing of the machining operations that need to be accomplished if the product is to be completed on schedule.

Although the surface details are different, the defining characteristics of the objects of interest are reasonably similar to those in military command and control and it appears that perception-action icons would provide a very effective interface design strategy for this domain. Direct perception could be achieved by a designing an icon that graphically represents the manufacturing goals and constraints associated with an individual product (e.g., machining operations and scheduled completion times relative to production goals). The direct perception of these constraints would clearly specify instances where the operator needs to override the automated scheduler to expedite the processing of a product that is late. In turn, the operator could execute this control input through the direct manipulation of these icons (i.e., dragging and dropping an icon on the graphical representation of a machining center or processing buffer). In summary, the results of the present evaluation and an analysis of the potential for generalization suggest that perception-action icons constitute an interface design strategy that will prove successful for other intermediate domains.

The foregoing detailed description and preferred embodiments therein are being given by way of illustration and example only; additional variations in form or detail will readily suggest themselves to those skilled in the art without departing from the spirit of the invention. Accordingly, the scope of the invention should be understood to be limited only by the appended claims.

We claim:

1. A graphical user interface for use as a near-real time resource deployment decision analysis tool on a computer provided with data corresponding to information about external resources, said graphical user interface comprising at least one perception action icon having a plurality of visual objects organizing the data into resource categories enabling instant comparison thereof and providing analog, digital, and categorical representations of status of the external resources within each of said resource categories based on the data, each one of said visual objects being configured to provide a visual change when a corresponding one of said resource categories changes said status at least from an update to the data.

2. A graphical user interface, as in claim 1, wherein said visual objects include any one or more of: color coded parameter mats, analog percentage indicators, color coded alpha-numeric symbols, categorical discrepancy indicators, digital values, bar graphs, color coded borders, and color coded background colors.

3. A graphical user interface, as in claim 1, wherein said visual change includes any one or more of: a color change of at least one of said visual objects, a change in location of at least one of said visual objects, a change in size of at least one of said visual objects, and a change in an alpha-numeric symbols of said visual object.

4. A graphical user interface, as in claim 1, wherein said resources are combat resources.

5. A graphical user interface, as in claim 1, wherein said at least one perception action icon further comprising a border configured to show a first color when said update to the data changes said status of one of said resource categories and to fade said first color as time passes to give an indication of time passing since last updating of the data represented by said visual objects.

6. A graphical user interface, as in claim 1, wherein said graphical user interface further provides a map display, said at least one perception action icon has a corresponding semi-transparent icon provided on said map display, and a cursor that can be positioned by a user on said at least one perception action icon to highlight said corresponding semi-transparent icon on said map display.

7. A graphical user interface, as in claim 1, wherein said graphical user interface further provides a map display, said at least one perception action icon has a corresponding semi-transparent icon provided on said map display, and a cursor that can be positioned by a user on said corresponding semi-transparent icon to show a munition envelope.

8. A graphical user interface, as in claim 1, wherein said graphical user interface further provides a normal operational mode screen having a friendly combat resources display section comprising said at least one perception action icon, a force ratio display section providing a graphical measurement in real time of friendly military power as represented by the data relative to enemy military power as represented by the data, an enemy combat resources display, and a map display, wherein said at least one perception action icon and said enemy combat resources display each has a corresponding semi-transparent icon provided on said map display.

9. A graphical user interface, as in claim 1, further comprising a review mode screen facilitating a user's capability to determine when progress and expenditures of said resources have deviated from a predetermined plan.

10. A graphical user interface, as in claim 1, further comprising a synchronization mode screen having a temporal synchronization matrix display illustrating temporal aspects of synchronization requirements in mission plans, and a spatial synchronization matrix display illustrating spatial aspects on a map provided in said graphical user interface of said synchronization requirements in said mission plans.

11. A method for providing generalized and detailed representations of data corresponding to information about external resources provided to a computer using a graphical user interface, the method comprising:
displaying said graphical user interface; and
displaying at least one perception action icon on said graphical user interface. said perception action icon having a plurality of visual objects organizing the data into resource categories enabling instant comparison thereof and providing analog, digital, and categorical representations of status of the external resources within each of said resource categories based on the data, each one of said visual objects being configured to provide a visual change when a corresponding one of said resource categories changes said status at least from an update to the data.

12. A method, as in claim 11, wherein said visual objects include any one or more of: color coded parameter mats, analog percentage indicators, color coded alpha-numeric symbols, categorical discrepancy indicators, digital values, bar graphs, color coded borders, and color coded background colors.

13. A method, as in claim 11, wherein said visual change includes any one or more of: a color change of at least one of said visual objects, a change in location of at least one of said visual objects, a change in size of at least one of said visual objects, and a change in an alpha-numeric symbols of said visual object.

14. A method, as in claim 11, wherein said at least one perception action icon further comprising a border configured to show a first color when said update to the data changes said status of one of said resource categories and to fade said first color as time passes to give an indication of time passing since last updating of the data represented by said visual objects.

15. A method, as in claim 11, further comprises providing a map display wherein said at least one perception action icon has a corresponding semi-transparent icon provided on said map display, and providing a cursor that can be positioned by a user on said at least one perception action icon to highlight said corresponding semi-transparent icon on said map display.

16. A method, as in claim 11, further comprises providing a map display wherein said at least one perception action icon has a corresponding semi-transparent icon provided on said map display, and providing a cursor that can be positioned by a user on said corresponding semi-transparent icon to show a munition envelope.

17. A method, as in claim 11, further comprises providing a normal operational mode screen of said graphical user interface, said normal operational mode screen having a friendly combat resources display section comprising said at least one perception action icon, a force ratio display section providing a graphical measurement in real time of friendly military power as represented by the data relative to enemy military power as represented by the data, an enemy combat resources display, and a map display, wherein said at least one perception action icon and said enemy combat resources display each has a corresponding semi-transparent icon provided on said map display.

18. A method, as in claim 11, further comprises providing a review mode screen of said graphical user interface, said review mode screen facilitating a user's capability to determine when progress and expenditures of said resources have deviated from a predetermined plan.

19. A method, as in claim 11, further comprises providing a synchronization mode screen of said graphical user interface, said synchronization mode screen having a temporal synchronization matrix display illustrating temporal aspects of synchronization requirements in mission plans, and a spatial synchronization matrix display illustrating spatial aspects on a map provided in said graphical user interface of said synchronization requirements in said mission plans.

20. A computer system provided with data corresponding to information about external resources, said computer system comprising a graphical user interface providing at least one perception action icon, said perception action icon having a plurality of visual objects organizing the data into resource categories and providing analog, digital, and categorical representations of status of the external resources within each of said resource categories based on the data, each one of said visual objects is configured to provide a visual change when a corresponding one of said resource categories changes said status at least in respects to an update to the data.
